(19) United States
(12) Patent Application Publication
(10) Pub. No.: US 2021/0248529 A1
(43) Pub. Date: Aug. 12, 2021

(54) INFORMATION PROCESSING APPARATUS, INFORMATION PROCESSING METHOD, AND STORAGE MEDIUM

(71) Applicant: LINK AND MOTIVATION INC., Tokyo (JP)

(72) Inventors: Yoshihisa OZASA, Tokyo (JP); Hideki SAKASHITA, Tokyo (JP)

(73) Assignee: LINK AND MOTIVATION INC., Tokyo (JP)

(21) Appl. No.: 17/270,346

(22) PCT Filed: Apr. 26, 2019
(86) PCT No.: PCT/JP2019/017877

§ 371 Date: Feb. 22, 2021

(30) Foreign Application Priority Data
Aug. 24, 2018 (JP) 2018-156869

(51) Int. Cl. G06Q 10/06

(52) U.S. Cl. CPC G06Q 10/0637; G06Q 10/067

(57) ABSTRACT

An information processing apparatus includes: a reference parameter storage in which a parameter is stored for each of one or more types of information, and for each piece of information that each type of information can have; an organization parameter storage in which a parameter is stored in association with an organization identifier; an information accepting unit that accepts one or more types of information; a parameter accumulating unit that acquires one or more parameters respectively corresponding to the one or more types of information, from the reference parameter storage, and accumulates the parameters in association with an organization identifier; a command accepting unit that accepts a command; a parameter acquiring unit that acquires a parameter paired with an organization identifier contained in the command; an improvement processing unit that performs processing for improving an organization, using the acquired parameter.

### TECHNICAL FIELD

The present invention relates to an information processing apparatus and the like that are used to improve an organization.

### BACKGROUND ART

Conventionally, there is a system capable of providing an individual belonging to a group, with advice for actions for improving a state of the group or the individual (see Patent Document 1).

Furthermore, there is an organization improvement activity assisting system for proposing a plan that matches a target organization, wherein the system accepts input of responses to question items regarding organization properties, from users of the organization, collects the responses, calculates an organization matching degree by quantifying the matching level to each of the contents that the organization properties can have, and proposes a recommended plan (see Patent Document 2).

Furthermore, there is a workplace improvement activity assisting apparatus including a part that accepts input of, and manages the activity status of a plan for improving a workplace of a target organization (see Patent Document 3).

Furthermore, there is a questionnaire analysis system that collects questionnaire response data, and analyzes and illustrates which question item has been gaining attention of respondents and how the trends of the collected result may change (see Patent Document 4).

Moreover, there is a technique for conducting a questionnaire regarding the motivation and the way of working of employees, diagnoses business conditions of the organization based on the questionnaire, and suggests a course of an improvement and reformation (see Patent Document 5).

### CITATION LIST

### Patent Documents

Patent Document 1: Japanese Patent No. 5854988

Patent Document 2: JP 2016-053898A

Patent Document 3: JP 2015-165364A

Patent Document 4: JP 2015-064666A

Patent Document 5: JP 2002-207844A

### SUMMARY OF INVENTION

### Technical Problem

However, conventional techniques depend on the personal ability of a consultant in order to suitably realize the function of the information processing apparatus for improving an organization.

Specifically, according to the conventional techniques, for example, a consultant sets various parameters for use in an information processing apparatus for improving an organization, using know-how of the consultant, based on a result of a hearing investigation conducted by the consultant on users.

### Solution to Problem

A first aspect of the present invention is directed to an information processing apparatus for improving an organization, including: a reference parameter storage unit in which one or at least two parameters that are used by the information processing apparatus are stored for each of one or more types of information out of organization skill information regarding an ability to implement a plan for an organization, business change information regarding a change in an environment of business that is done by an organization, company control information regarding control in an organization, and information transfer information regarding how information is transferred in an organization, and for each piece of information that each type of information can have; an organization parameter storage unit in which one or at least two parameters are stored in association with an organization identifier for identifying an organization; an information accepting unit that accepts one or at least two types of information out of organization skill information, business change information, company control information, and information transfer information, in association with an organization identifier for identifying an organization; a parameter accumulating unit that acquires one or more parameters respectively corresponding to the one or more types of information accepted by the information accepting unit, from the reference parameter storage unit, and accumulates the one or more parameters in association with an organization identifier associated with the one or more types of information accepted by the information accepting unit, in the organization parameter storage unit; a command accepting unit that accepts a command associated with an organization identifier; a parameter acquiring unit that acquires one or more parameters paired with an organization identifier contained in the command accepted by the command accepting unit, from the organization parameter storage unit; and an improvement processing unit that performs processing for improving an organization, using the one or more parameters acquired by the parameter acquiring unit.

With this configuration, it is easy to suitably realize the function of the information processing apparatus for improving an organization.

More specifically, with this configuration, it is possible to set various parameters for use in the information processing apparatus, based on input from a user, without using special know-how of a consultant. Accordingly, it is possible to operate the information processing apparatus, without depending on the ability of a consultant.

Furthermore, a second aspect of the present invention is directed to the information processing apparatus according to the first aspect, further including: an item information storage unit in which one or more pieces of item information are stored in association with each of at least two parameters, wherein one or more parameters that are used to conduct a questionnaire for an organization improvement are stored in association with an organization identifier in the organization parameter storage unit, and the improvement processing unit that acquires one or more pieces of item information corresponding to the one or more parameters acquired by the parameter acquiring unit, from the item information storage unit, and configures and outputs a questionnaire.

With this configuration, it is easy to suitably conduct a questionnaire in order to improve an organization.

Furthermore, a third aspect of the present invention is directed to the information processing apparatus according to the first aspect, further including: an action plan storage unit in which one or more action plans for an organization improvement are stored in association with each of at least two parameters, wherein one or more parameters that are used to propose an action plan for an organization improvement are stored in association with an organization identifier in the organization parameter storage unit, and the improvement processing unit acquires one or more action plans for an organization improvement from the action plan storage unit, using the one or more parameters acquired by the parameter acquiring unit, and outputs the action plans.

With this configuration, it is easy to propose a proper action plan in order to improve an organization.

Furthermore, a fourth aspect of the present invention is directed to the information processing apparatus according to the first aspect, wherein a parameter regarding a frequency for conducting a questionnaire for an organization improvement is stored in association with an organization identifier in the organization parameter storage unit, and the improvement processing unit outputs prompting information for prompting conduction of a questionnaire such that the frequency matches the parameter regarding the conduction frequency.

With this configuration, it is easy to conduct a questionnaire at a suitable point in time in order to improve an organization.

Furthermore, a fifth aspect of the present invention is directed to the information processing apparatus according to the first aspect, wherein a parameter regarding a method for conducting a questionnaire for an organization improvement is stored in association with an organization identifier in the organization parameter storage unit, and the improvement processing unit accepts a response of a questionnaire through a different route according to the parameter regarding the conducting method, and accumulates the response.

With this configuration, it is easy to conduct a questionnaire using a suitable method in order to improve an organization.

Furthermore, a sixth aspect of the present invention is directed to the information processing apparatus according to the first aspect, wherein providable information that is provided to an organization is stored in association with a parameter in the reference parameter storage unit, and the improvement processing unit acquires and outputs providable information paired with each of the one or more parameters acquired by the parameter acquiring unit.

With this configuration, it is easy to provide information in order to improve an organization.

Furthermore, a seventh aspect of the present invention is directed to the information processing apparatus according to any one of the first to sixth aspects, further including: a preliminary item information storage unit in which one or more pieces of preliminary item information are stored, the preliminary item information being item information for deciding on one or more types of information out of organization skill information, business change information, company control information, and information transfer information; and a preliminary item information output unit that outputs the one or more pieces of preliminary item information, wherein the improvement processing unit accepts a response of a questionnaire, and accumulates the response, the preliminary item information output unit outputs the one or more pieces of preliminary item information before the improvement processing unit accepts a response of a first questionnaire, and the information accepting unit accepts one or more types of information out of organization skill information, business change information, company control information, and information transfer information, in response to outputs of the one or more pieces of preliminary item information.

With this configuration, it is possible to properly set a parameter before conducting a questionnaire for improving an organization.

### Advantageous Effects of Invention

With information processing apparatus according to the present invention, it is easy to suitably realize the function of the information processing apparatus for improving an organization.

### BRIEF DESCRIPTION OF DRAWINGS

FIG. 1 is a conceptual diagram of an information system A in Embodiment 1.

FIG. 2 is a block diagram of the information system A in this embodiment.

FIG. 3 is a block diagram of an information processing apparatus 1 constituting the information system A in this embodiment.

FIG. 4 is a flowchart illustrating an operation example of the information processing apparatus 1 in this embodiment.

FIG. 5 is a flowchart illustrating a detailed operation example of the improvement processing in this embodiment.

FIG. 6 is a flowchart illustrating score calculating processing in this embodiment.

FIG. 7 shows an item information management table in this embodiment.

FIG. 8 shows organization response information in this embodiment.

FIG. 9 shows an individual score table in this embodiment.

FIG. 10 shows an organization information management table in this embodiment.

FIG. 11 shows a preliminary item information management table in this embodiment.

FIG. 12 shows a reference parameter management table in this embodiment.

FIG. 13 shows an action plan management table in this embodiment.

FIG. 14 shows an organization parameter management table in this embodiment.

FIG. 15 shows an example of a preliminary questionnaire screen in this embodiment.

FIG. 16 shows an example of a preliminary questionnaire screen in this embodiment.

FIG. 17 shows an example of a screen of a terminal apparatus 2 in this embodiment.

FIG. 18 shows an example of a screen of a focus survey in this embodiment.

FIG. 19 is a schematic view of a computer system in this embodiment.

FIG. 20 is a block diagram of the computer system in this embodiment.

### DESCRIPTION OF EMBODIMENT

Hereinafter, an embodiment of an information processing apparatus and the like will be described with reference to the drawings. It should be noted that constituent elements denoted by the same reference numerals in the embodiments perform similar operations, and thus a description thereof may not be repeated.

### Embodiment 1

In this embodiment, an information processing system including an information processing apparatus that accepts one or more types of information out of later-described organization skill information, later-described business change information, later-described company control information, and later-described information transfer information, sets a parameter according to the accepted information, and use the parameter for an organization improvement will be described.

Note that, in this embodiment, processing for an organization improvement is, for example, conducting a questionnaire, processing that proposes an action plan, notifying that it is time to conduct a questionnaire for an organization improvement, or providing information for an organization improvement corresponding to an automatically set parameter.

Furthermore, in this embodiment, a configuration will be described in which one or more types of information out of organization skill information, business change information, company control information, and information transfer information are accepted before a questionnaire is conducted. That is to say, in this embodiment, an information processing system including an information processing apparatus that accepts one or more types of information out of organization skill information, business change information, company control information, and information transfer information before actual use of the information processing apparatus, and automatically sets a parameter that is used to actually operate the information processing apparatus will be described.

Note that the information system may also be said to be an engagement system. The information processing apparatus may also be said to be an engagement apparatus.

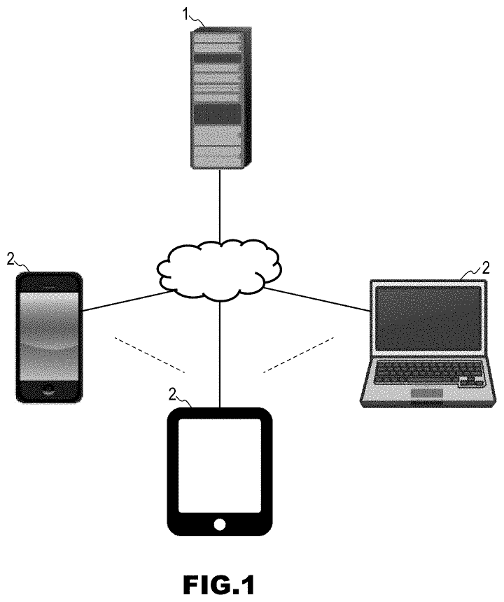

FIG. 1 is a conceptual diagram of an information system A in this embodiment. The information system A includes an information processing apparatus 1 and one or at least two terminal apparatuses 2. The information processing apparatus 1 in this example is a so-called server apparatus. The information processing apparatus 1 is, for example, a cloud server or an ASP server, and there is no limitation on the type or installation location thereof. Each terminal apparatus 2 is a mobile terminal such as a smartphone, a tablet device, or a mobile phone, a so-called personal computer, or the like, and there is no limitation on the type thereof.

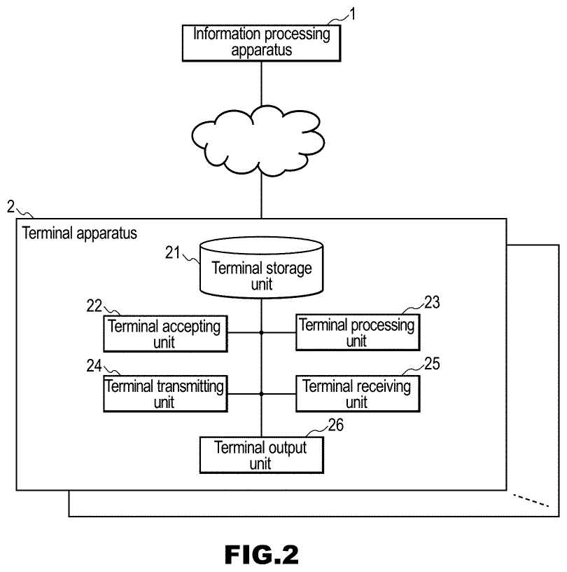

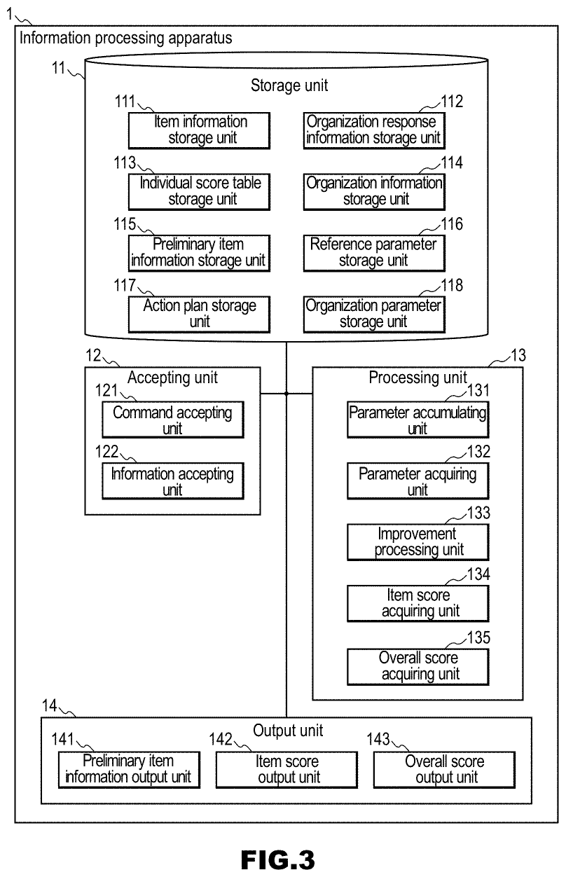

FIG. 2 is a block diagram of the information system A in this embodiment. FIG. 3 is a block diagram of the information processing apparatus 1 constituting the information system A.

The information processing apparatus 1 constituting the information system A includes a storage unit 11, an accepting unit 12, a processing unit 13, and an output unit 14.

The storage unit 11 includes an item information storage unit 111, an organization response information storage unit 112, an individual score table storage unit 113, an organization information storage unit 114, a preliminary item information storage unit 115, a reference parameter storage unit 116, an action plan storage unit 117, and an organization parameter storage unit 118.

The accepting unit 12 includes a command accepting unit 121 and an information accepting unit 122.

The processing unit 13 includes a parameter accumulating unit 131, a parameter acquiring unit 132, an improvement processing unit 133, an item score acquiring unit 134, and an overall score acquiring unit 135.

The output unit 14 includes a preliminary item information output unit 141, an item score output unit 142, and an overall score output unit 143.

Each terminal apparatus 2 includes a terminal storage unit 21, a terminal accepting unit 22, a terminal processing unit 23, a terminal transmitting unit 24, a terminal receiving unit 25, and a terminal output unit 26.

In the storage unit 11 constituting the information processing apparatus 1, various types of information are stored. The various types of information are, for example, later-described item information, later-described organization response information, later-described individual score table, later-described organization information, later-described preliminary item information, later-described reference parameter, later-described action plan information, later-described organization parameter, and the like. The individual score table may also be said to be an engagement score table or the like.

In the item information storage unit 111, one or more pieces of item information are stored in association with each of at least two parameters. The parameters are, for example, “organization diagnosis” and “focus survey”. “Organization diagnosis” and “focus survey” may be regarded as information indicating the type of questionnaire or the type of research.

“Organization diagnosis” is, for example, information indicating that a questionnaire having questions of both a later-described overall item and a later-described individual item is to be implemented. “Focus survey” is, for example, information indicating that a questionnaire having questions of only a later-described overall item is to be implemented.

It is also possible that the item information in the item information storage unit 111 is not associated with a parameter.

The item information is information regarding an item of an organization. The item may be a question regarding an organization. The item may be associated with a question regarding an organization. The at least two items include, for example, an overall item regarding an overall matter of an organization, and an individual item, which is an individual item of the organization. The overall item is typically an item for a question with a high abstraction degree. The individual item is typically an item for a question with a lower abstraction degree (a more specific question). The at least two pieces of item information in the item information storage unit 111 have, for example, item information of four overall items and item information of 64 individual items. Each item corresponds to, for example, any one of the at least two targets. A target may also be said to be a factor. The target may also be said to be a matter regarding an organization. The item information has, for example, an item identifier for identifying an item, and question information. The item identifier is, for example, an ID, an item name, or the like. The item identifier may be question information itself. The question information is information indicating a question. The question is typically a question in a questionnaire. The matter may also be said to be a target or an item.

In the organization response information storage unit 112, organization response information of at least two organizations are stored. The organization response information is information indicating a response to a question to an organization member. The question may also be said to be a topic or an item. The information indicating a response may be simply said to be a response.

Furthermore, the organization response information is typically associated with an organization identifier for identifying an organization. The organization identifier is an organization name, an ID for identifying an organization, or the like. The organization response information is typically associated with one or more organization attribute values. Each organization attribute value is an attribute value of an organizations. The organization attribute value is, for example, an industry type identifier indicating an industry type of an organization (e.g., bank, apparel, manufacturer, etc.), a size identifier for classifying a size of an organization (e.g., large enterprise, small-to-medium sized enterprise, micro enterprise, self-employed, etc.), information indicating a category of an organization based on business conditions of an organization (e.g., in the black, in the red, etc.), a region identifier indicating the region of a home office, a sector identifier for identifying a sector in an organization (e.g., human-resources, accounting, laboratory, engineering sector, sales sector, manufacturing sector, etc.), a listing identifier indicating whether or not, an organization is listed, a stage identifier indicating a stage of an organization (e.g., founding period, expansion period, diversification period, revitalization period, etc.), a business model identifier indicating a business model (e.g., innovator business that performs multiple types of businesses, professional business that performs a small number of businesses such as one business and depends on people, operator business that performs a small number of businesses such as one business and depends on systems, etc.), or the like. The industry type may be rough classification such as financing company, manufacturer, trading company, service industry, or the like, or fine classification such as bank, securities company electronics manufacturer, food manufacturer, machine manufacturer, or the like. It will be appreciated that there is no limitation on how to classify industry types and the like.

One piece of organization response information is a group of information on responses from at least two members of one organization. One piece of organization response information has at least two pieces of member response information respectively corresponding to at least two members. The member response information is information containing a response of a member to a question for an item. The member response information has at least two pieces of item response information. The number of pieces of item response information contained in the member response information is typically the same as the number of items. The item response information has an item identifier and response information. The response information is information regarding a response to a question. The response information has, for example, satisfaction level information. The satisfaction level information is information indicating a response regarding a satisfaction level of a member to an item. The satisfaction level information is, for example, information for specifying a satisfaction level to an item. The satisfaction level information is classified into at least two classes. The satisfaction level information may take, for example, any natural number of 1 to 5. Note that the satisfaction level information may be, for example, an evaluation value, such as A, B, and C, having the rank or order, or may be any natural number of 1 to 100, for example. The response information has, for example, satisfaction level information and expectation level information. The expectation level information is information indicating a response regarding an expectation level of a member to an item. The expectation level information is, for example, information for specifying an expectation level to an item. The expectation level information is classified into at least two classes. The expectation level information may take, for example, any natural number of 1 to 5. Note that the expectation level information is, for example, an evaluation value, such as A, B, and C, having the rank or order, or may be any natural number of 1 to 100, for example. There is no limitation on the content of items, questions, and the like. The member is, for example, an employee of a company; a staff member of a school, a staff member of a government office, or the like, but may also include an executive of a company and the like. The member may be a non-regular worker or the like. Moreover, the level of being satisfied may be regarded as a concept that encompasses the levels of positive feels similar to satisfaction, such as the level of being content, the level of feeling good, and the like. The expectation level may be regarded as a concept that also encompasses those similar thereto, such as the level of being important.

The overall item is, for example, a company satisfaction level indicating a level of being satisfied with a company; a job satisfaction level indicating a level of being satisfied with a job, a supervisor satisfaction level indicating a level of being satisfied with a supervisor, a workplace satisfaction level indicating a level of being satisfied with a workplace, or the like. The individual item is, for example, a business superiority of a company, transmission and transfer of a strategic objective, a sense of overall solidarity, validity of evaluation and salary or the like.

In the individual score table storage unit 113, an individual score table is stored. The individual score table in this example is, information for deciding on an item score when satisfaction level information and expectation level information are given. The individual score table in this example is, for example, a table having an axis of satisfaction level information and an axis of expectation level information, wherein table cells respectively show individual scores, so that, if satisfaction level information and expectation level information are decided on, an item score is decided on. This individual score table is preferably a table in which the larger the satisfaction level indicated by the satisfaction level information is, the larger the acquired item score is, and the smaller the expectation level indicated by the expectation level information is, the larger the acquired item score is.

It is also possible to decide on an item score, using an operation expression having, as parameters, satisfaction level information and expectation level information. This operation expression is preferably an increasing function having, as a parameter, satisfaction level information, and a decreasing function having, as a parameter, expectation level information.

Furthermore, it is also possible to learn multiple sets of satisfaction level information, expectation level information, and an item score through machine learning, and to decide on an item score using the acquired learning information. In this case, satisfaction level information and expectation level information are applied to learning information, and an item score is acquired through machine learning. As the machine learning in this example, for example, SVR, deep learning, decision trees, random forests, and the like are available. Note that there is no limitation on the algorithm of the machine learning.

In the organization information storage unit 114, at least two pieces of organization information are stored. The organization information is information regarding an organization. The organization information has an organization identifier and one or more organization attribute values. It is preferable that the organization information has an organization identifier, an organization attribute value, and an overall score, which is an overall score for an organization. The overall score may be an absolute overall score not depending on an organization attribute value.

In the preliminary item information storage unit 115, one or at least two pieces of preliminary item information are stored, the preliminary item information being item information for deciding on one or more types of information out of organization skill information, business change information, company control information, and information transfer information.

The organization skill information is information indicating the level at which a member in a managerial position in charge of an action plan for an organization improvement is skilled in an organization. The organization skill information may also be said to be information regarding an ability to implement a plan for an organization. The organization skill information is preferably an organization skill level that is quantitative information, but may also be qualitative information. The organization skill level may be, for example, any one of “skilled (e.g., the value “3”)”, “intermediate (e.g., the value “2”)”, and “beginner-level (e.g., the value “1”)”.

The business change information is information indicating the speed at which business is changing. The business change information may also be said to be information regarding a change in an environment of business that is done by an organization. The business change information is preferably a business change level that is quantitative information, but may also be qualitative information. The business change level may be, for example, any one of “stable (e.g., the value “3”)”, “start to be stable (e.g., the value “2”)”, and “continue to change (e.g., the value “1”)”.

The company control information is information indicating the level at which a company is controlled. The company control information may also be said to be information regarding control in an organization. The company control information is preferably a company control level that is quantitative information, but may also be qualitative information. The company control level may be, for example, any one of “centralized (e.g., the value “3”)”, “transitional (e.g., the value “2”)”, and “decentralized (e.g., the value “1”)”.

The information transfer information is information indicating the way in which information is transferred in an organization. The information transfer information may also be said to be information regarding how information is transferred in an organization. The information transfer information is preferably an information transfer level that is quantitative information, but may also be qualitative information. The information transfer level may be, for example, any one of “transfer via virtual contact (e.g., the value “3”)”, “normal (e.g., the value “2”)”, and “transfer via real contact (e.g., the value “1”)”.

The item information for deciding on the organization skill information is, for example, a question asking the organization skill information, and is “which organization management ability is the ability of a member in a managerial position in charge of an action plan closer to?”, for example.

The item information for deciding on the business change information is, for example, a question asking the business change information, and is “which speed is the speed of a business change closer to?”, for example.

The item information for deciding on the company control information is, for example, a question asking the company control information, and is “which management method is the method of an organization closer to'?”, for example.

The item information for deciding on the information transfer information is, for example, a question asking the information transfer information, and is “which information transfer method is the method in a company closer to?”, for example.

In the reference parameter storage unit 116, one or at least two parameters that are used by the information processing apparatus 1 are stored for each of one or at least two types of information out of organization skill information, business change information, company control information, and information transfer information, and for each piece of information that each type of information can have. It is preferable that, in the reference parameter storage unit 116, at least two parameters are stored for each of at least two types of information out of organization skill information and the like, and for each piece of information that each type of information can have. The information in the reference parameter storage unit 116 may also be said to be information regarding consultant's know-how and ability.

It is preferable that providable information that is provided to an organization is stored in association with a parameter in the reference parameter storage unit 116. The providable information is, for example, information regarding an employment position of a person in charge of an action plan, and is, for example, “low employment position”, “intermediate employment position”, and “high employment position”. The providable information is, for example, the way in which a senior executive is involved in processing for an organization improvement, and is, for example, “check progress (regularly keep track of a progress status while leaving an action plan to a person in charge)”, “provide consultation (provide an opportunity to ask for consultation about execution of an action plan)”, “approve and assist (keep an eye on the progress of an action plan, encourage and talk to a person in charge, and assist if the progress is not made). The providable information is, for example, information regarding support for an organization improvement, from those other than senior executives, and, for example, “basically no support (by oneself)”, “assist in a company (e.g., assist skill/motivation with support from a person in charge of an operation)”, “assist from a consulting firm (e.g., assist skill/motivation through an optional training session, session for sharing the situation with everyone)”.

In the action plan storage unit 117, one or more action plans for an organization improvement are stored in association with each of one or at least two parameters. Each action plan is a recommend plan for an organization improvement. The action plan is, for example, “provide an opportunity to interact with other departments”, “set a scene for greater understanding of the personnel system”, or the like.

In the organization parameter storage unit 118, one or more parameters are stored in association with an organization identifier for identifying an organization. Each parameter may also be said to be a value or information.

It is also possible that, in the organization parameter storage unit 118, one or more pieces of providable information are stored in association with an organization identifier. In this case, it is preferable that, in the organization parameter storage unit 118, a parameter is not stored in association with an organization identifier. In this case, it may be regarded that a parameter and providable information corresponding to each other are the same.

In the organization parameter storage unit 118, one or more parameters that are used to conduct a questionnaire for an organization improvement are stored in association with an organization identifier. Each parameter that is used to conduct a questionnaire is, for example, the value of “conducting questionnaire conduction frequency”, the value of “time to conduct questionnaire”, or the value of “intervals between questionnaires conducted”.

In the organization parameter storage unit 118, one or more parameters that are used to propose an action plan for an organization improvement are stored in association with an organization identifier. Each parameter that is used to propose an action plan is, for example, the value of “improvement item/number of actions”.

In the organization parameter storage unit 118, a parameter regarding a frequency for conducting a questionnaire for an organization improvement is stored in association with an organization identifier.

In the organization parameter storage unit 118, a parameter regarding a method for conducting a questionnaire for an organization improvement is stored in association with an organization identifier.

The accepting unit 12 accepts various types of information or instructions. The various types of information or instructions are, for example, a later-described command, the organization skill information, the business change information, the company control information, the information transfer information, the organization response information, questionnaire response information (the member response information or the organization response information), or the like. The accepting is typically receiving from the terminal apparatus 2, but may be considered as a concept that also encompasses accepting information input from an input device such as a keyboard, a mouse, or a touch panel, accepting information read from a storage medium such as an optical disk, a magnetic disk, or a semiconductor memory and the like.

The command accepting unit 121 accepts a command. The command accepting unit 121 accepts a command associated with an organization identifier, for example. The command is, for example, a command to realize the function of the improvement processing unit 133. The command is, for example, a parameter setting command, which is an instruction to set a parameter, a questionnaire conducting command, which is an instruction to transmit a questionnaire, an action plan proposing command, which is an instruction to transmit an action plan, or an information providing command, which is an instruction to transmit providable information corresponding to a parameter of an organization. The parameter setting command is typically a command that is accepted before the questionnaire conducting command, the action plan proposing command, and the information providing command are accepted. That is to say, the parameter setting command is typically an instruction to set a parameter that is accepted before the actual function of the information processing apparatus 1 is realized.

The accepting is typically receiving from the terminal apparatus 2, but may be considered as a concept that also encompasses accepting information input from an input device such as a keyboard, a mouse, or a touch panel, accepting information read from a storage medium such as an optical disk, a magnetic disk, or a semiconductor memory and the like.

The information accepting unit 122 accepts one or more types of information out of organization skill information, business change information, company control information, and information transfer information, in association with an organization identifier for identifying an organization. The information accepting unit 122 may accept organization response information.

It is preferable that the information accepting unit 122 accepts one or more types of information out of organization skill information, business change information, company control information, and information transfer information, in response to outputs of the one or more pieces of preliminary item information. The output is typically transmission to the terminal apparatus 2, but is a concept that also encompasses display on a display screen, projection using a projector, printing by a printer, output of a sound, accumulation in a storage medium, delivery of a processing result to another processing apparatus or another program, and the like.

The processing unit 13 performs various types of processing. The various types of processing are, for example, processes that are performed by the parameter accumulating unit 131, the parameter acquiring unit 132, the improvement processing unit 133, the item score acquiring unit 134, the overall score acquiring unit 135, and the like. The various types of processing are, for example, a process that accumulates received organization response information, received member response information, received organization information, and the like in the storage unit 11.

The parameter accumulating unit 131 acquires one or at least two parameters respectively corresponding to the one or more types of information accepted by the accepting unit 12, from the reference parameter storage unit 116, and accumulates the one or more parameters in the organization parameter storage unit 118 in association with an organization identifier associated with the one or more types of information accepted by the accepting unit 12.

The parameter acquiring unit 132 acquires one or at least two parameters paired with an organization identifier contained in the command accepted by the command accepting unit 121, from the organization parameter storage unit 118.

The parameter acquiring unit 132 acquires one or at least two parameters paired with an organization identifier contained in the command accepted by the command accepting unit 121 and that correspond to an accepted command, from the organization parameter storage unit 118.

Note that, in the parameter acquiring unit 132, for example, information for specifying a parameter is held in association with a command. In the parameter acquiring unit 132, for example, information is held in which the command “questionnaire conducting command” and the parameter identifiers “parameter indicating whether or not to conduct organization diagnosis”, “parameter indicating whether or not to conduct focus survey”, “frequency for conducting engagement survey”, “frequency for conducting focus survey”, and “frequency for conducting questionnaire” are associated with each other.

The improvement processing unit 133 performs processing for improving an organization, using the one or at least two parameters acquired by the parameter acquiring unit 132.

Note that the processing for improving an organization is, for example, providing information for processing such as conduction of a questionnaire for an organization improvement (e.g., transmission of a questionnaire having one or more pieces of item information to the terminal apparatus 2), or proposal of an action plan (e.g., transmission of an action plan to the terminal apparatus 2), setting and outputting a default value for processing such as conduction of a questionnaire for an organization improvement or proposal of an action plan, transmission of information indicating that it is time to conduct a questionnaire for an organization improvement, to the terminal apparatus 2, changing a screen for an organization improvement that is to be output at the terminal apparatus 2 (e.g., making a specific button unselectable, making a specific menu unselectable, etc.), changing the processing flow for an organization improvement, or the like.

For example, the improvement processing unit 133 acquires one or more pieces of item information corresponding to the one or more parameters acquired by the parameter acquiring unit 132, from the item information storage unit 111, and configures and outputs a questionnaire. The output is, for example, transmission to the terminal apparatus 2.

For example, the improvement processing unit 133 acquires one or more action plans for an organization improvement, using the one or more parameters acquired by the parameter acquiring unit 132, from the action plan storage unit 117, and outputs the action plans. For example, the improvement processing unit 133 acquires one or more action plans paired with the one or more parameters acquired by the parameter acquiring unit 132, from the action plan storage unit 117, and outputs the action plans. The output is, for example, transmission to the terminal apparatus 2.

For example, the improvement processing unit 133 outputs prompting information for prompting conduction of a questionnaire such that the frequency matches the parameter regarding the conduction frequency. For example, the improvement processing unit 133 acquires information indicating the conduction time of a previous questionnaire (e.g., date information) from the storage unit 11, and acquires information indicating the conduction time of a next questionnaire using the parameter regarding the conduction frequency and outputs prompting information for prompting conduction of a questionnaire when the conduction time indicated by the information and the acquired current date are close, to each other enough to satisfy a predetermined condition. The output is, for example, transmission to the terminal apparatus 2.

For example, the improvement processing unit 133 accepts a response of a questionnaire through a different route according to the parameter regarding the conducting method, and accumulates the response. For example, the improvement processing unit 133 receives only responses associated with an organization identifier of an organization with the parameter regarding the conducting method being “WEB”, from the terminal apparatus 2, and accumulates the responses in the organization response information storage unit 112. For example, if the parameter regarding the conducting method is not “WEB”, the improvement processing unit 133 collectively receives organization response information of an organization having multiple members, and accumulates the information in the organization response information storage unit 112.

For example, the improvement processing unit 133 acquires providable information paired with each of the one or more parameters acquired by the parameter acquiring unit 132, from the reference parameter storage unit 116, and outputs the information.

For example, the improvement processing unit 133 accepts a response of a questionnaire, and accumulates the response in the organization response information storage unit 112. The accepted response of a questionnaire is typically associated with an organization identifier.

For example, the improvement processing unit 133 accepts member response information from each member, and accumulates the member response information in the organization response information storage unit 112, in association with an organization identifier of an organization of that member. For example, the improvement processing unit 133 collectively accepts organization response information in association with an organization identifier, and accumulates the member response information in the organization response information storage unit 112, in association with an organization identifier.

The item score acquiring unit 134 performs statistical processing on the response information of the members to the at least two items contained in the at least two pieces of organization response information, thereby acquiring an item score for each organization and for each item.

For example, the item score acquiring unit 134 performs, for each organization, statistical processing on the satisfaction level information contained in the response information of the at least two items contained in the organization response information of the organization, thereby acquiring an item score for each organization and for each item. For example, the item score acquiring unit 134 may calculate an average value of the satisfaction level information for each organization and for each item, and accumulate the average value as an item score in an unshown buffer or the storage unit 11 so as to be paired with the item identifier. For example, the item score acquiring unit 134 may for each organization and for each item, perform different weighting according to a member's attribute value, calculate a weighted average value of the satisfaction level, and accumulate the weighted average value as an item score in an unshown buffer or the storage unit 11 so as to be paired with the item identifier. The member's attribute value is, for example, the position, the length of service, the sex, or the like. For example, the item score acquiring unit 134 may calculate a weighted average value while making the weight of the satisfaction level information of a long-service employee greater than that of a short-service employee.

The item score acquiring unit 134 acquires item scores of at least some of the items, using the satisfaction level information and the expectation level information. The item for which an item score is acquired using the satisfaction level information and the expectation level information is, for example, an individual item.

It is preferable that the item score acquiring unit 134 acquires an item score, for example, such that the higher the satisfaction level information is, the higher the score is, and such that the lower the expectation level information is, the higher the score is.

The item score acquiring unit 134 calculates, for example, for each of the at least two organizations and for each of the at least two items, an average value of the satisfaction level information contained in the response information and an average value of the expectation level information contained in the response information, and acquires an item score for each item using the two average values.

The item score acquiring unit 134 may, for example, apply the satisfaction level information and the expectation level information to the individual score table, thereby acquiring an item score for each item. The item score acquiring unit 134 may, for example, apply a statistical processing result of the satisfaction level information and a statistical processing result of the expectation level information to the individual score table, thereby acquiring an item score for each item. The item score acquiring unit 134 may, for example, apply an average value of the satisfaction level information and an average value of the expectation level information to the individual score table, thereby acquiring an item score for each item. The item score acquiring unit 134 may, for example, apply a weighted average value of the satisfaction level information and a weighted average value of the expectation level information to the individual score table, thereby acquiring an item score for each item. The weighted average value is a weighted average value based on a member's attribute value.

The item score acquiring unit 134 may, for example, calculate an item score for each item, using a function that is an increasing function having, as a parameter, an average value of the satisfaction level information, and is a decreasing function having, as a parameter, an average value of the expectation level information.

In the description above, the process in which the item score acquiring unit 134 calculates a so-called absolute item score was described. The absolute item score is an item score that does not depend on an organization identifier such as the industry type, and is acquired typically-only from response information corresponding to organization identifier of one organization.

Note that it is also possible that the item score acquiring unit 134 calculates a so-called relative item score. That is to say, the item score acquiring unit 134 acquires, for example, an item score according to an organization attribute value. In this case, the item score acquiring unit 134 calculates, for example, an absolute item score of each item of the organization. Then, the item score acquiring unit 134 calculates, for example, a relative item score, using one or more item scores acquired from response information corresponding to one or more organization identifiers paired with the same organization attribute value (e.g., the same industry type) as the organization attribute value of the organization.

The item score acquiring unit 134 calculates, for example, a deviation of the absolute item score of the organization, using an item score of an organization identified with one or at least two organization identifiers paired with the same organization attribute value as that of the organization. Techniques for calculating a relative item score, which is a deviation of one absolute item score, using multiple absolute item scores are well known.

Furthermore, the item score acquiring unit 134 may for example, calculate an average value of at least two absolute item scores acquired from response information corresponding to one or more organization identifiers paired with the same organization attribute value as that of the organization, and acquire a relative item score, using a difference between the average value and the absolute item score of the organization. This relative item score may be a difference itself between an average value of item scores and the absolute item score of the organization, or may be a value calculated by substituting this difference as a parameter for an operation expression.

That is to say there are various conceivable methods for calculating a relative item score of one organization, using absolute item scores of multiple organizations corresponding to the same organization attribute value. The same organization attribute value means that one or at least two organization attribute values are the same. The item score acquiring unit 134 may, for example, calculate a relative item score of a company of interest among multiple companies of the same industry type, or may calculate a relative item score of a company of interest among multiple companies within a category of the same industry type and with a similar size, for each item.

The overall score acquiring unit 135 acquires an overall score for at least two pieces of organization response information, using at least two item scores. The overall score is an overall score of an organization. Typically, the higher each of the at least two item scores is, the higher the overall score acquired by the overall score acquiring unit 135 is.

The overall score acquiring unit 135 acquires an attribute value-considering overall score, which is a score of an organization identified with an organization identifier contained in a command, for example, and is a score of the organization according to one or at least two organization attribute values paired with the organization identifier, using multiple pieces of organization response information.

That is to say, the overall score acquiring unit 135 may, for example, acquire an attribute value-considering overall score, which is a relative overall score of one organization, among multiple organizations matching the condition configured using one or at least two organization attribute values. For example, the overall score acquiring unit 135 may, for example, acquire an attribute value-considering overall score of “laboratory+engineering sector” of A company, which is a manufacturer, from the response information of employees belonging to a laboratory or an engineering sector of a specific organization (e.g., A company), among multiple organizations with the type identifier “manufacturer” and the sector identifier “laboratory or engineering sector”. In this case, the condition is “(industry type identifier=manufacturer) AND (sector identifier=laboratory OR engineering sector)”. The overall score acquiring unit 135 acquires, for example, an absolute overall score, using at least two absolute item scores.

Furthermore, the overall score acquiring unit 135 acquires, for example, an attribute value-considering overall score, which is a relative overall score, using at least two relative item scores.

The overall score acquiring unit 135 preferably acquires an overall score using a score adjusting function as follows. The score adjusting function is a function of adjusting a score using correlation information regarding the degree of correlation between the satisfaction level information and the expectation level information. In this example, it is preferable to set the score adjusting function such that the higher the correlation between the satisfaction level information and the expectation level information is, the higher the overall score is.

The overall score acquiring unit 135 acquires, for example, for each organization, a tentative overall score, which is a tentative overall score of each organization, using at least two item scores, acquires correlation information regarding the degree of correlation between the satisfaction level information and the expectation level information for each of the at least two items, and acquires an overall score from the tentative overall score using the correlation information such that the higher the degree of correlation is, the higher the score is. The correlation information may be a correlation value between a group of satisfaction level information and a group of expectation level information for at least two items, a value calculated using an operation expression that is an increasing function having, as a parameter, the number of items in which a difference between satisfaction level information for each of the at least two items and expectation level information for each of the at least two items is less than or equal to a threshold, or a value calculated using an operation expression that is a decreasing function having, as a parameter, the number of items in which a difference between satisfaction level information for each of the at least two items and expectation level information for each of the at least two items is less than or equal to a threshold, and the satisfaction level information is smaller. That is to say, there is no limitation on the algorithm for acquiring correlation information.

The overall score acquiring unit 135 preferably acquires an overall score, using both item scores of overall items and item scores of individual items while making the weights of item scores of overall items greater than those of item scores of the individual items. Also in this case, the overall score acquiring unit 135 can acquire an absolute overall score, using an absolute item score. Also, the overall score acquiring unit 135 can acquire an attribute value-considering overall score, using a relative item score.

The overall score acquiring unit 135 may for example, calculate an overall score, using the equation “overall score=α×statistical score of item scores of overall items+β×statistical score of item scores of individual items”. In this example, it is preferable that (α>β). That is to say the overall score acquiring unit 135 preferably acquires an overall score while making the weights of item scores of overall items greater than those of item scores of the individual items. For example, “α=0.7, β=0.3”. The statistical score of item scores of overall items is, for example, an average value, a weighted average value, or the like of item scores of overall items. The statistical score of item scores of individual items is, for example, an average value, a weighted average value, or the like of item scores of individual items.

Furthermore, the overall score acquiring unit 135 may, for example, calculate a tentative overall score, using the equation “tentative overall score=α×statistical score of item scores of overall items+β×statistical score of item scores of individual items”, perform score adjustment using the above-described score adjusting function, and calculate an overall score. The overall score acquiring unit 135 may, for example, calculate a deviation of an overall score of each organization, using overall scores of multiple organizations, and take the deviation as a final overall score.

The overall score acquiring unit 135 acquires an overall score and an organization attribute value paired with an organization identifier contained in an output instruction, and acquires an attribute value-considering overall score, which is a score of an organization according to the organization attribute value, using the overall score and the organization attribute value. The attribute value-considering overall score may be regarded as a relative overall score that depends on an organization attribute value. Also, the attribute value-considering overall score may also be said to be a relative engagement score. The organization attribute value in this case is one or at least two organization attribute values.

The overall score acquiring unit 135 acquires, for example, an attribute value-considering overall score, which is a score of an organization identified with an organization identifier contained in a command, and is a score of the organization according to an organization attribute value paired with the organization identifier; using multiple pieces of organization response information.

The overall score acquiring unit 135 acquires an overall score and an organization attribute value paired with an organization identifier contained in a command, and acquires an attribute value-considering overall score, using the overall score and the organization attribute value. The overall score in this example is an absolute overall score, and the attribute value-considering overall score is a relative overall score.

The overall score acquiring unit 135 acquires an attribute value-considering overall score, using the at least two relative item scores acquired by the item score acquiring unit 134. Typically, the higher the relative item score is, the higher the attribute value-considering overall score acquired by the overall score acquiring unit 135 is. The overall score acquiring unit 135 acquires, for example, an attribute value-considering overall score, using an increasing function (e.g., an average value, a weighted average value, a sum, etc.) having, as a parameter, the at least two relative item scores acquired by the item score acquiring unit 134. For example, a correspondence table of groups of at least two relative item scores and attribute value-considering overall scores is stored in the storage unit 11, and, referring to the correspondence table, the overall score acquiring unit 135 acquires an attribute value-considering overall score corresponding to the at least two relative item scores acquired by the item score acquiring unit 134, from the correspondence table.

The output unit 14 outputs various types of information. The various types of information are, for example, later-described one or more pieces of preliminary item information, a questionnaire, and an overall score. The various types of information are, for example, a group of information composed of pairs of an item identifier and an item score. The item score may be either an absolute item score or a relative item score. The various types of information are, for example, an absolute overall score or a relative overall score. The output is typically transmission to an external apparatus such as the terminal apparatus 2. Note that the output may be considered as a concept that also encompasses display on a display screen, projection using a projector, printing by a printer, output of a sound, accumulation in a storage medium, delivery of a processing result to another processing apparatus or another program, and the like.

The preliminary item information output unit 141 outputs the one or more pieces of preliminary item information. The one or more pieces of preliminary item information are information stored in the preliminary item information storage unit 115. The output is typically transmission to the terminal apparatus 2, but may also be display on a display screen or the like.

It is preferable that the preliminary item information output unit 141 transmits one or more pieces of preliminary item information to the terminal apparatus 2 corresponding to one organization before the improvement processing unit 133 corresponding to the one organization accepts a response of a first questionnaire.

The item score output unit 142 outputs one or at least two item scores. The item score output unit 142 typically outputs an item score of an item identified with an item identifier, in association with the item identifier. The item score may be either the above-described absolute item score or relative item score.

The item score output unit 142 outputs, for example, an item score paired with an organization identifier contained in an output instruction, in association with the item identifier. It is preferable that the item score output unit 142 outputs one or more item scores, in association with the organization identifier. It is preferable that the item score output unit 142 outputs item scores such that item scores of overall items and item scores of individual items can be visually distinguished from each other.

The overall score output unit 143 outputs an overall score. It is preferable that the overall score output unit 143 outputs an overall score in association with the organization identifier.

The overall score output unit 143 may output an absolute overall score. It is preferable that the overall score output unit 143 outputs an absolute overall score in association with an organization identifier.

In the terminal storage unit 21 constituting the terminal apparatus 2, various types of information are stored. The various types of information are, for example, an organization identifier for identifying an organization of a user. The various types of information are, for example, information received by the terminal receiving unit 25. The organization identifier may be regarded as information for identifying a user.

The terminal accepting unit 22 accepts various types of instructions, information, or the like. The accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory, and the like. That is to say, the various types of instructions, information, or the like may be input by any part such as a touch panel, a keyboard, a mouse, a menu screen, or the like.

Furthermore, the various types of instructions, information, or the like are, for example, organization skill information, business change information, company control information, information transfer information, organization response information, questionnaire response information, organization information having an organization identifier and an organization attribute value, a parameter setting command, a questionnaire conducting command, an information providing command, or the like.

The terminal processing unit 23 performs various types of processing. The various types of processing are, for example, a process that configures data that is to be displayed, from the information received by the terminal receiving unit 25. The various types of processing are, for example, a process that configures instructions or the like that is to be transmitted, from the instructions or the like accepted by the terminal accepting unit 22.

The terminal transmitting unit 24 transmits the various types of instructions, information, or the like to the information processing apparatus 1. The various types of instructions, information, or the like are, for example, the instructions configured by the terminal processing unit 23, or the instructions, information, or the like accepted by the terminal accepting unit 22.

The terminal receiving unit 25 receives various types of information from the information processing apparatus 1. The various types of information are, for example, preliminary item information, proposal information, overall score, absolute or relative item scores, or a questionnaire.

The terminal output unit 26 acquires various types of information. The various types of information are, for example, the information accepted by the terminal accepting unit 22, the information received by the terminal receiving unit 25, or the information configured by the terminal processing unit 23. The various types of information are, for example, preliminary item information, proposal information, or overall score.

The storage unit 11, the item information storage unit 111, the organization response information storage unit 112, the individual score table storage unit 113, the organization information storage unit 114, the preliminary item information storage unit 115, the reference parameter storage unit 116, the action plan storage unit 117, the organization parameter storage unit 118, and the terminal storage unit 21 are preferably non-volatile storage media, but can also be realized by volatile storage media.

There is no limitation on the procedure in which information is stored in the storage unit 11 and the like. For example, information may be stored in the storage unit 11 and the like via a storage medium, information transmitted via a communication line or the like may be stored in the storage unit 11 and the like, or information input via an input device may be stored in the storage unit 11 and the like.

The accepting unit 12, the command accepting unit 121, the information accepting unit 122, and the terminal receiving unit 25 are typically realized by wireless or wired communication parts, but can also be realized by broadcast receiving parts.

The processing unit 13, the parameter accumulating unit 131, the parameter acquiring unit 132, the improvement processing unit 133, the item score acquiring unit 134, the overall score acquiring unit 135, and the terminal processing unit 23 are realized typically by MPUs, memories, or the like. Typically, the processing procedure of the processing unit 13 and the like is realized by software, and the software is stored in a storage medium such as a ROM. Note that they may be realized also by hardware (dedicated circuits).

The output unit 14, the preliminary item information output unit 141, the item score output unit 142, the overall score output unit 143, and the terminal transmitting unit 24 are typically realized by wireless or wired communication parts, but can also be realized by broadcasting parts.

The terminal accepting unit 22 may be realized as a device driver for an input part such as a touch panel or a keyboard, software for controlling a menu screen, or the like.

The terminal output unit 26 may be considered to include or to not include an output device such as a display screen or a speaker. The terminal output unit 26 may be realized by driver software for an output device, a combination of driver software for an output device and the output device, or the like.

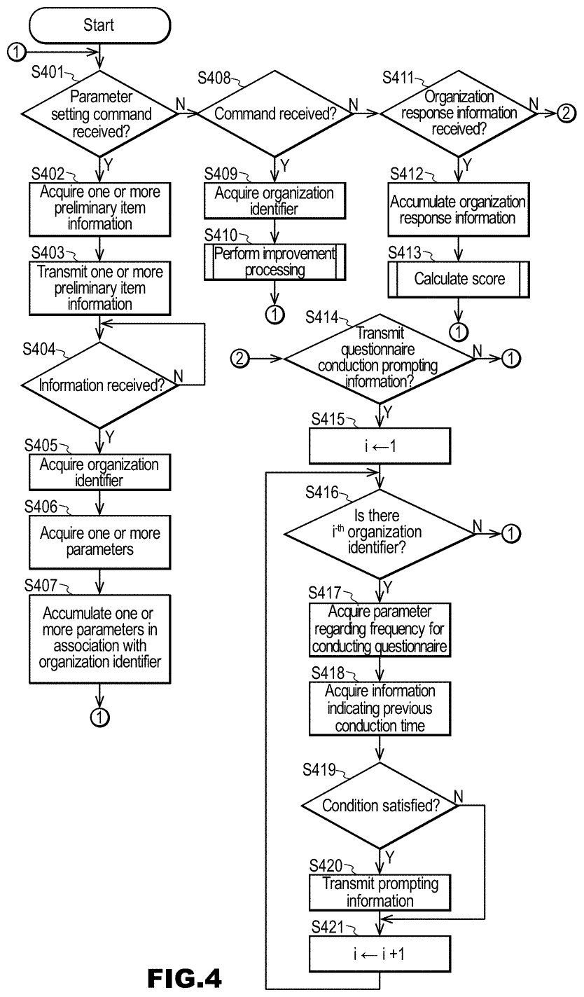

Next, an operation of the information system A will be described. First, an operation example of the information processing apparatus 1 will be described with reference to the flowchart in FIG. 4. It is assumed that, in the organization response information storage unit 112, organization response information of multiple organizations is stored. Also, it is assumed that, in the individual score table storage unit 113, an individual score table is stored.

(Step S401) The command accepting unit 121 judges whether or not it has received a parameter setting command from the terminal apparatus 2. If it has received a parameter setting command, the procedure advances to step S402, and, if otherwise, the procedure advances to step S408.

(Step S402) The processing unit 13 acquires one or more pieces of preliminary item information from the preliminary item information storage unit 115.

(Step S403) The output unit 14 transmits the one or more pieces of preliminary item information acquired in step S402, to the terminal apparatus 2 from which the parameter setting command was transmitted.

(Step S404) The information accepting unit 122 judges whether or not it has received one or more types of information out of organization skill information, business change information, company control information, and information transfer information, in association with an organization identifier for identifying an organization. If it has received one or more types of information, the procedure advances to step S405, and, if otherwise, the procedure returns to step S404. This information is received based on the transmission of one or more pieces of preliminary item information. In this step, for example, it is also possible that a situation such as that when a predetermined period of time has elapsed is regarded as timeout, and the procedure returns to step S401. In this case, there is no limitation on the time to receive one or more types of information out of organization skill information, business change information, company control information, and information transfer information.

(Step S405) The parameter accumulating unit 131 acquires an organization identifier corresponding to the information received in step S404.

(Step S406) The parameter accumulating unit 131 acquires one or more parameters paired with each of the one or more types of information received in step S404, from the reference parameter storage unit 116.

(Step S407) The parameter accumulating unit 131 accumulates the one or more parameters acquired in step S406 in the organization parameter storage unit 118, in association with the organization identifier acquired in step S405. The procedure returns to step S401.

(Step S408) The command accepting unit 121 judges whether or not it has received a command for processing that is performed for an organization improvement, from the terminal apparatus 2. If it has received a command, the procedure advances to step S409, and, if otherwise, the procedure advances to step S411. The command is received so as to be in association with the organization identifier.

(Step S409) The improvement processing unit 133 acquires an organization identifier corresponding to the command received in step S408.

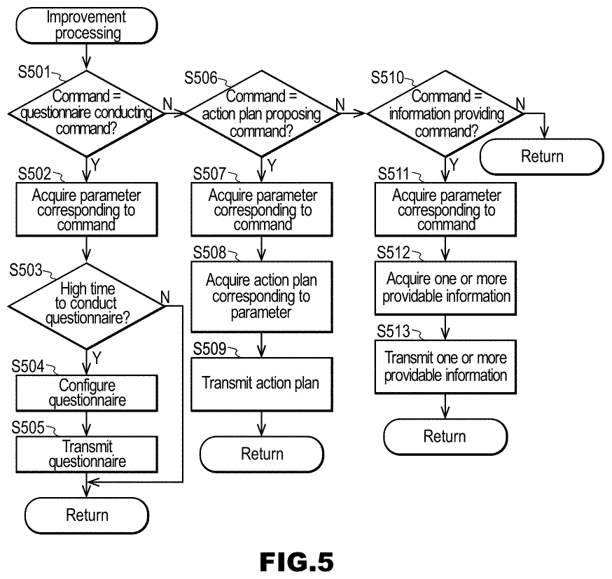

(Step S410) The improvement processing unit 133 performs improvement processing. The procedure returns to step S401. Hereinafter, a detailed operation example of the improvement processing will be described with reference to the flowchart in FIG. 5. The improvement processing is processing useful in improving an organization, and there may be various types of such processing.

(Step S411) The information accepting unit 122 judges whether or not it has received organization response information. If it has received organization response information, the procedure advances to step S412, and, if otherwise, the procedure advances to step S414.

(Step S412) The processing unit 13 accumulates the organization response information received in step S411, in the organization response information storage unit 112.

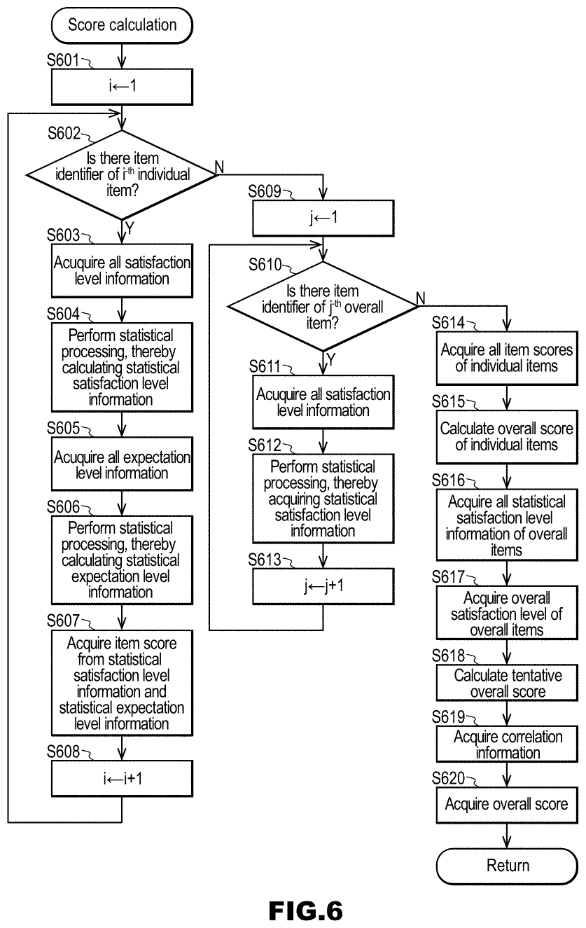

(Step S413) The item score acquiring unit 134 and the overall score acquiring unit 135 calculate a score, using the organization response information. Hereinafter, the score calculating processing will be described with reference to the flowchart in FIG. 6. There is no limitation on the time to calculate a score.

(Step S414) The improvement processing unit 133 judges whether or not it is time to transmit questionnaire conduction prompting information. If it is time to transmit questionnaire conduction prompting information, the procedure advances to step S415, and, if otherwise, the procedure returns to step S401. There is no limitation on the time to transmit questionnaire conduction prompting information, and examples thereof include those such as regular times, or a date and time set in advance, and the like.

(Step S415) The improvement processing unit 133 substitutes 1 for a counter i.

(Step S416) The improvement processing unit 133 judges whether or not there is an i^{-th} organization identifier in the organization information storage unit 114. If there is an i^{-th} organization identifier, the procedure advances to step S417, and, if otherwise, the procedure returns to step S401.

(Step S417) The improvement processing unit 133 acquires a parameter regarding a frequency for conducting a questionnaire, out of the parameters paired with the i^{-th} organization identifier, from the organization parameter storage unit 118. The parameter regarding a frequency for conducting a questionnaire may also be a parameter for specifying time to conduct a questionnaire.

(Step S418) The improvement processing unit 133 acquires information paired with the i^{-th} organization identifier and indicating the conduction time of a previous questionnaire, from the storage unit 11. In this case, for example, when organization response information is received, the processing unit 13 accumulates information indicating the conduction time, which is information indicating the date and time when the organization response information was received, in the storage unit 11, so as to be paired with the organization identifier.

(Step S419) The improvement processing unit 133 acquires information indicating the current date from an unshown clock, an NLP server, or the like. The improvement processing unit 133 judges whether or not a predetermined condition is satisfied, based on the information indicating the conduction time of a previous questionnaire, the information indicating the current date, and the parameter regarding a frequency for conducting a questionnaire. If the condition is satisfied, the procedure advances to step S420, and, if otherwise, the procedure advances to step S421. The predetermined condition is that period information acquired from the information indicating the conduction time of a previous questionnaire and the information indicating the current date matches period information specified with the parameter regarding a frequency for conducting a questionnaire, or close thereto enough to satisfy a predetermined condition, for example.

(Step S420) The improvement processing unit 133 acquires prompting information for prompting conduction of a questionnaire, from the storage unit 11, and makes a notification to a contact address indicated by contact address information (e.g., an e-mail address, an ID, etc.) paired with the i^{-th} organization identifier. The prompting information is, for example, information indicating that it is time to conduct a questionnaire, or that it is about time to conduct a questionnaire. The prompting information is stored, for example, in the storage unit 11.

(Step S421) The improvement processing unit 133 increments the counter i by 1. The procedure returns to step S416.

In the flowchart shown in FIG. 4, processing ends at power off or at an interruption of ending processing.

Next, a detailed operation example of the improvement processing in step S410 will be described with reference to the flowchart in FIG. 5.

(Step S501) The parameter acquiring unit 132 judges whether or not a received command is a questionnaire conducting command. If the command is a questionnaire conducting command, the procedure advances to step S502, and, if otherwise, the procedure advances to step S506.

(Step S502) The parameter acquiring unit 132 acquires one or more parameters paired with the organization identifier acquired in step S409 and corresponding to the questionnaire conducting command, from the organization parameter storage unit 118. The one or more parameters are, for example, a parameter regarding a frequency for conducting a questionnaire, or a parameter for specifying a questionnaire that is to be conducted (e.g., a parameter indicating whether or not to conduct an organization diagnosis, or a parameter indicating whether or not to conduct a focus survey).

(Step S503) The improvement processing unit 133 judges whether or not it is high time to conduct a questionnaire. If it is high time to conduct a questionnaire, the procedure advances to step S504, and, if otherwise, the procedure returns to the upper-level processing. The improvement processing unit 133 judges whether or not it is high time to conduct a questionnaire based on whether or not a condition is satisfied, in a similar way to that of step S419, through the processing described in steps S417 to S410.

(Step S504) The improvement processing unit 133 acquires one or at least two pieces of item information corresponding to the parameter (e.g., a parameter for specifying a questionnaire that is to he conducted) acquired in step S502, from the item information storage unit 111. The improvement processing unit 133 configures a questionnaire, using the acquired one or more pieces of item information.

(Step S505) The improvement processing unit 133 transmits the questionnaire configured in step S504, to the terminal apparatus 2 from which the command was transmitted. The procedure returns to the upper-level processing.

(Step S506) The improvement processing unit 133 judges whether or not a received command is an action plan proposing command. If the command is an action plan proposing command, the procedure advances to step S507, and, if otherwise, the procedure advances to step S510.

(Step S507) The improvement processing unit 133 acquires one or more parameters paired with the organization identifier acquired in step S409 and corresponding to the action plan proposing command, from the organization parameter storage unit 118.

(Step S508) The improvement processing unit 133 acquires one or more action plans corresponding to the one or more parameters acquired in step S507, from the action plan storage unit 117.

(Step S509) The improvement processing unit 133 transmits the one or more action plans acquired in step S508, to the terminal apparatus 2 from which the command was transmitted. The procedure returns to the upper-level processing.

(Step S510) The improvement processing unit 133 judges whether or not a received command is an information providing command. If the command is an information providing command, the procedure advances to step S511, and, if otherwise, the procedure returns to the upper-level processing.

(Step S511) The improvement processing unit 133 acquires one or more parameters paired with the organization identifier acquired in step S409 and corresponding to information providing command, from the organization parameter storage unit 118.

(Step S512) The improvement processing unit 133 acquires one or more pieces of providable information corresponding to the one or more parameters acquired in step S511, from the reference parameter storage unit 116.

(Step S513) The improvement processing unit 133 transmits the one or more pieces of providable information acquired in step S508, to the terminal apparatus 2 from which the command was transmitted. The procedure returns to the upper-level processing.

In the flowchart shown in FIG. 5, it is also possible that the improvement processing unit 133 performs other types of improvement processing.

Next, an example of the score calculating processing in step S413 will be described with reference to the flowchart in FIG. 6.

(Step S601) The item score acquiring unit 134 substitutes 1 for a counter i.

(Step S602) The item score acquiring unit 134 judges whether or not there is an item identifier of an i^{-th} individual item, in the received organization response information. If there is an item identifier of an i^{-th} individual item, the procedure advances to step S603, and, if otherwise, the procedure advances to step S609.

(Step S603) The item score acquiring unit 134 acquires satisfaction level information of all members paired with the item identifier of the i^{-th} individual item, in the received organization response information.

(Step S604) The item score acquiring unit 134 performs statistical processing on the satisfaction level information acquired in step S603, thereby calculating statistical satisfaction level information. In this case, for example, the item score acquiring unit 134 calculates statistical satisfaction level information, which is an average value of the satisfaction level information acquired in step S603. Then, the item score acquiring unit 134 accumulates the calculated statistical satisfaction level information in the storage unit 11 or an unshown buffer so as to be paired with the item identifier of the i^{-th} individual item.

(Step S605) The item score acquiring unit 134 acquires expectation level information of all members paired with the item identifier of the i^{-th} individual item, in the received organization response information.

(Step S606) The item score acquiring unit 134 performs statistical processing on the expectation level information acquired in step S605, thereby calculating statistical expectation level information. In this case, for example, the item score acquiring unit 134 calculates statistical expectation level information, which is an average value of the expectation level information acquired in step S603. Then, the item score acquiring unit 134 accumulates the calculated statistical expectation level information in the storage unit 11 or an unshown buffer so as to be paired with the item identifier of the i^{-th} individual item.

(Step S607) The item score acquiring unit 134 acquires an item score of the i^{-th} individual item of the organization of interest, using the statistical satisfaction level information and the statistical expectation level information. The item score acquiring unit 134 applies the statistical satisfaction level information and the statistical expectation level information to the individual score table in the individual score table storage unit 113, thereby acquiring an item score of the i^{-th} individual item. Then, the item score acquiring unit 134 accumulates the acquired item score in the storage unit 11 or an unshown buffer so as to be paired with the item identifier of the i^{-th} individual item.

(Step S608) The item score acquiring unit 134 increments the counter i by 1. The procedure returns to step S602.

(Step S609) The item score acquiring unit 134 substitutes 1 for a counter j.

(Step S610) The item score acquiring unit 134 judges whether or not there is an item identifier of a j^{-th} overall item, in the received organization response information. If there is an item identifier of a j^{-th} overall item, the procedure advances to step S611, and, if otherwise, the procedure advances to step S614.

(Step S611) The item score acquiring unit 134 acquires satisfaction level information of all members paired with the item identifier of the j^{-th} overall item, in the received organization response information.

(Step S612) The item score acquiring unit 134 performs statistical processing on the satisfaction level information acquired in step S611, thereby calculating statistical satisfaction level information. In this case, for example, the item score acquiring unit 134 calculates statistical satisfaction level information, which is an average value of the satisfaction level information acquired in step S611. Then, the item score acquiring unit 134 accumulates the calculated statistical satisfaction level information in the storage unit 11 or an unshown buffer so as to be paired with the item identifier of the j^{-th} overall item.

(Step S613) The item score acquiring unit 134 increments the counter j by 1. The procedure returns to step S610.

(Step S614) The overall score acquiring unit 135 acquires all item scores of the individual items, from the storage unit 11 or an unshown buffer. The item scores of the individual items are scores acquired in step S607.

(Step S615) The overall score acquiring unit 135 acquires an overall score of the individual items, from all item scores acquired in step S614. For example, the overall score acquiring unit 135 calculates an average value of all item scores acquired in step S614, and acquires the average value as an overall score of the individual items.

(Step S616) The overall score acquiring unit 135 acquires statistical satisfaction level information of all items of the overall items, from the storage unit 11 or an unshown buffer.

(Step S617) The overall score acquiring unit 135 performs statistical processing on the statistical satisfaction level information of all items acquired in step S616, thereby calculating statistical satisfaction level information of the overall items. For example, the overall score acquiring unit 136 calculates an average value of the statistical satisfaction level information of all items acquired in step S616, and acquires the average value as statistical satisfaction level information of the overall items.

(Step S618) The overall score acquiring unit 135 calculates a tentative overall score, from the overall score of the individual items acquired in step S616 and the statistical satisfaction level information of the overall items acquired in step S617. For example, the overall score acquiring unit 135 calculates a tentative overall score, using the operation expression “tentative overall score=α×statistical satisfaction level information of overall items+β×overall score of individual items”.

(Step S619) The overall score acquiring unit 135 acquires correlation information regarding correlation between a group of the satisfaction level information and a group of the expectation level information, from the group of the satisfaction level information of all individual items and the group of the expectation level information of all individual items.

(Step S620) The overall score acquiring unit 135 adjusts the tentative overall score acquired in step S618, using the correlation information acquired in step S619, thereby acquiring an overall score. The procedure returns to the upper-level processing. The overall score acquiring unit 135 acquires an overall score such that the higher the degree of correlation indicated by the correlation information is, the higher the overall score is.

Next, an operation of the terminal apparatus 2 will be described. The terminal accepting unit 22 of the terminal apparatus 2 accepts various types of instructions, information, or the like. Next, the terminal processing unit 23 configures instructions or the like that is to be transmitted, from the instructions or the like accepted by the terminal accepting unit 22. The terminal transmitting unit 24 transmits the instructions or the like configured by the terminal processing unit 23, to the information processing apparatus 1. In response to transmission of the instructions or the like, the terminal receiving unit 25 receives information from the information processing apparatus 1. Next, the terminal processing unit 23 configures data that is to be output, from the information received by the terminal receiving unit 25. Next, the terminal output unit 26 outputs the information configured by the terminal processing unit 23.

Hereinafter, a specific operation of the information system A in this embodiment will be described. FIG. 1 is a conceptual diagram of the information system A.

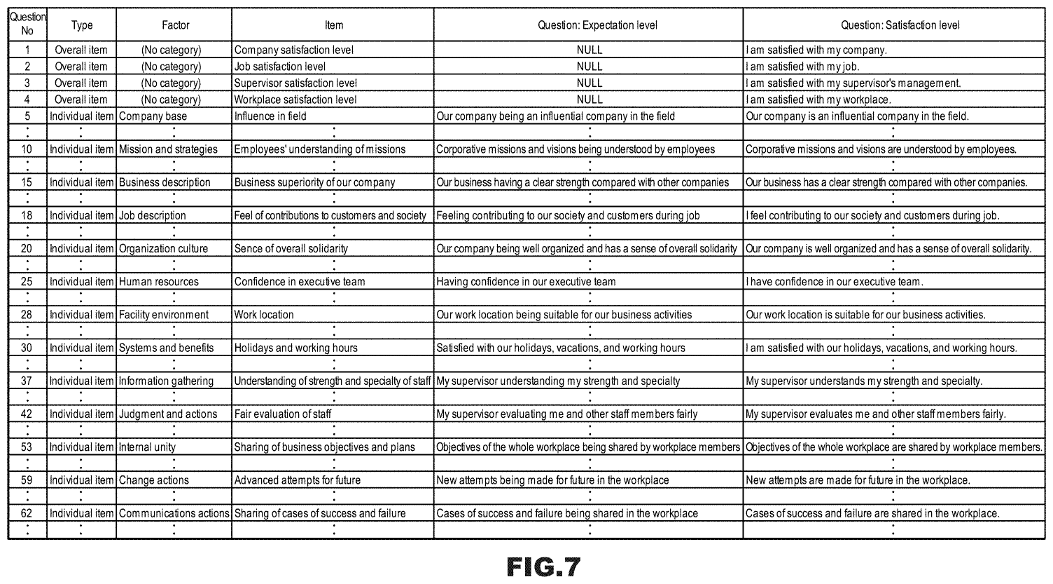

It is assumed that the item information management table shown in FIG. 7 is stored in the item information storage unit 111. The item information management table is a table for managing a large number of pieces of item information each indicating an item of a questionnaire to a member (an employee in this example) of an organization (a company in this example). The item information in this example has “question No”, “type”, “factor”, “item”, “question: expectation level”, and “question: satisfaction level”. “Question No” is an ID for identifying a question, and is an example of an item identifier. “Type” is information indicating the type of item, and, in this example, may be either an overall item or an individual item. “Factor” is a middle concept of an item, and may also be said to be a target. “Item” is information indicating the content of an item. “Item” may he regarded as an item identifier. “Question: expectation level” is a question for acquiring expectation level information. “Question: satisfaction level” is a question for acquiring satisfaction level information.

It is assumed that, in FIG. 7, records with the question Nos “1” to “4” are associated with the questionnaire type “focus survey”. Furthermore, it is assumed that, in FIG. 7, records with the question Nos “5” and thereafter are associated with the questionnaire type “organization diagnosis”. It is also possible that records with the question Nos “1” to “4” are also associated with the questionnaire type “focus survey”.

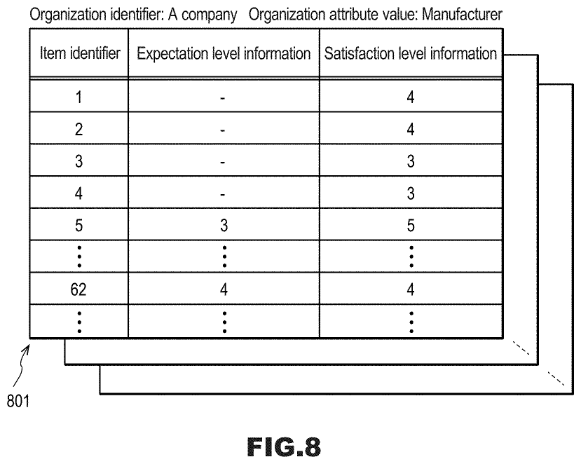

Furthermore, for example, the organization response information with the structure as shown in FIG. 8 is stored in the organization response information storage unit 112. At least two pieces of organization response information are stored in the organization response information storage unit 112. FIG. 8 shows organization response information of an organization identified with the organization identifier “A company”. 801 denotes member response information of one employee of the organization identified with the organization identifier “A company”. The organization response information of an organization identified with the organization identifier “A company” contains member response information of at least two employees. The member response information has a large number of (63 or more, in this example) records each having “item identifier”, “expectation level information”, and “satisfaction level information”. The record of an item with an item identifier of 1 to 4 is a record of an overall item, and has no expectation level information. Then, the expectation level information and the satisfaction level information constituting the member response information of 801 are information acquired from responses of an employee to “question: expectation level” and “question: satisfaction level” of the item information management table shown in FIG. 7. This responses in this example are responses indicated by a natural number of 1 to 5. In this example, if the expectation level information to “question: expectation level” is 1, the expectation level is lowest, and, if the expectation level information is 5, the expectation level is highest. If the satisfaction level information to “Question: satisfaction level” is 1, the satisfaction level is lowest, and, if the satisfaction level information is 5, the satisfaction level is highest. Furthermore, it is assumed that the organization attribute value of the industry type of the organization identified with the organization identifier “A company” is “manufacturer”. The industry type is an example of the organization attribute. It is assumed that multiple pieces of response information of organizations corresponding to the organization attribute value “manufacturer” are stored in the organization response information storage unit 112.

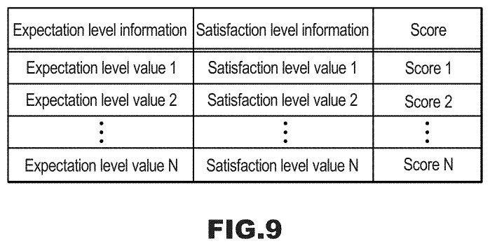

Furthermore, the individual score table shown in FIG. 9 is stored in the individual score table storage unit 113. In the individual score table, at least two records each having “expectation level information”, “satisfaction level information”, and “score” are managed. “Expectation level information” is, for example, an average value of the expectation level information. “Expectation level information” may be, for example, information indicating the range of an average value of the expectation level information. “Expectation level value 1”, “expectation level value 2” . . . , and “expectation level value N”, which are attribute values of “expectation level information”, are information indicating specific values or ranges. “Satisfaction level information” is, for example, an average value of the satisfaction level information. “Satisfaction level information” may be, for example, information indicating the range of an average value of the satisfaction level information. “Satisfaction level value 1”, “satisfaction level value 2” . . . , and “satisfaction level value N”, which are attribute values of “satisfaction level information”, are information indicating specific values or ranges. “Score” in this example is information indicating an item score. “Score 1”, “score 2” . . . , and “score N”, which are attribute values of “score”, are specific values.

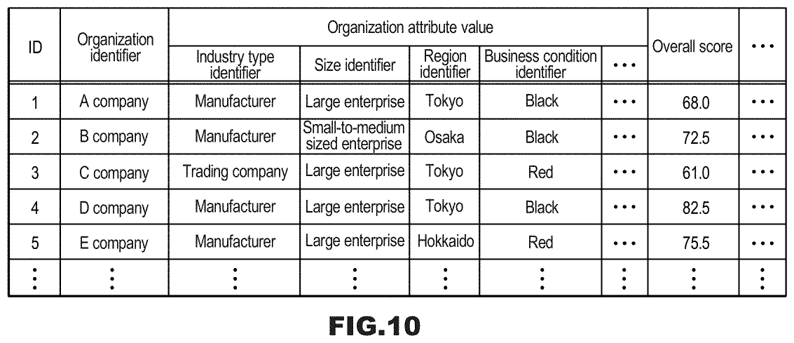

Furthermore, the organization information management table shown in FIG. 10 is stored in the organization information storage unit 114. The organization information management table is a table for managing organization information. The organization information management table has at least two records each having “ID”, “organization identifier”, “organization attribute value”, “overall score”, and the like. “organization attribute value” in this example has “industry type identifier”, “size identifier”, “region identifier”, “business conditions identifier”, and the like. “Industry type identifier” is information for identifying an industry type, in this example, such as manufacturer, trading company, bank, or the like. “Size identifier” is information for identifying a size of an organization, such as large enterprise, small-to-medium sized enterprise, micro enterprise, self-employed, or the like. “Region identifier” is information for identifying a location of a home office of an organization (company etc.), such as any one of the prefectures. “Business conditions identifier” is information for identifying a business condition, such as being the black or the red, or the like.

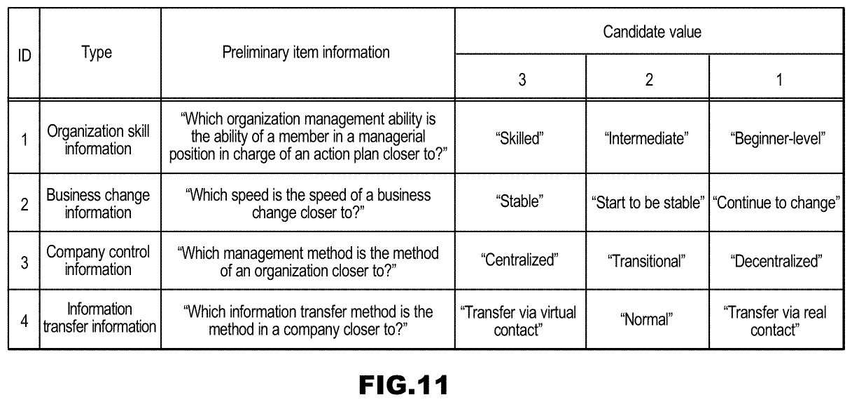

Furthermore, the preliminary item information management table shown in FIG. 11 is stored in the preliminary item information storage unit 115. The preliminary item information management table manages multiple records each having “ID”, “type”, “preliminary item information”, and “candidate value”. “ID” is information for identifying a record. “Type” indicates the type of information that is accepted, and, in this example, may he any one of organization skill information, business change information, company control information, and information transfer information. “Preliminary item information” is a question for deciding on any one of organization skill information, business change information, company control information, and information transfer information. “Candidate value” is information that the user may input for the preliminary item information to the terminal apparatus 2, and, in this example, is any one of “1”, “2”, and “3”. The meaning of each type of information is stored for the values “1”, “2”, and “3”, as attribute values of “candidate value” in FIG. 11.

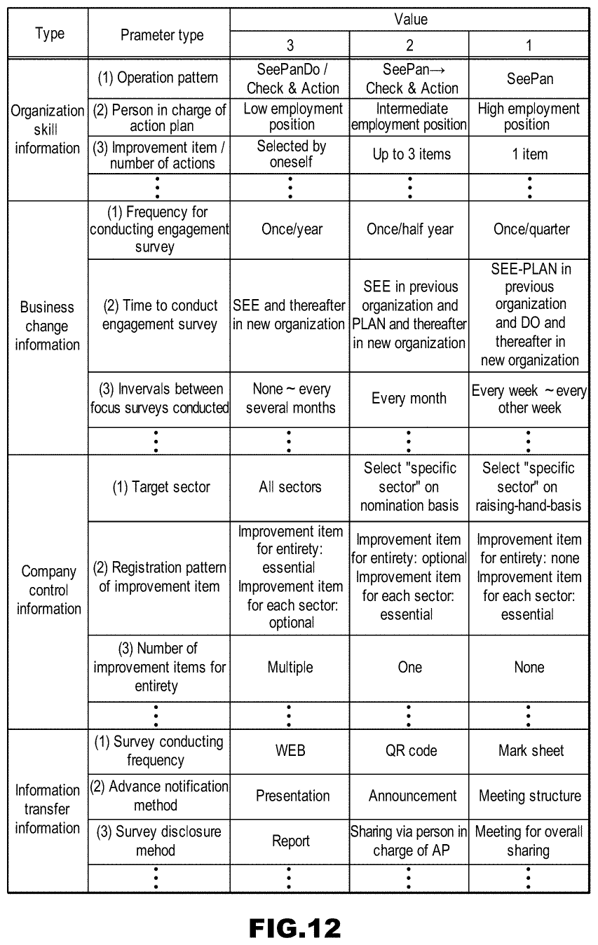

Furthermore, the reference parameter management table shown in FIG. 12 is stored in the reference parameter storage unit 116. The reference parameter management table manages multiple records each having “type”, “parameter type”, and “value”. “Type” is the type of information, and, in this example, is any one of organization skill information, business change information, company control information, and information transfer information. “Parameter type” is a parameter identifier for identifying the type of parameter (which may also be said to be “variable”). “Value” is a value that may be used. as a parameter. “Value” is paired with “candidate value” that may be any one of “1”, “2”, and “3”. That is to say in FIG. 12, for example, if the organization skill information is “3”, the parameter “3” is substituted for the parameter type “operation pattern”. The parameter “3” in this case corresponds to the providable information “SeePlanDo/Check&Action”. In FIG. 12, if the business change information is “1”, the parameter “1” is substituted for the parameter type “frequency for conducting engagement survey”. The parameter “1” in this case corresponds to the providable information “Once/quarter, closing/evaluation/reorganization/transfer are performed every quarter”.

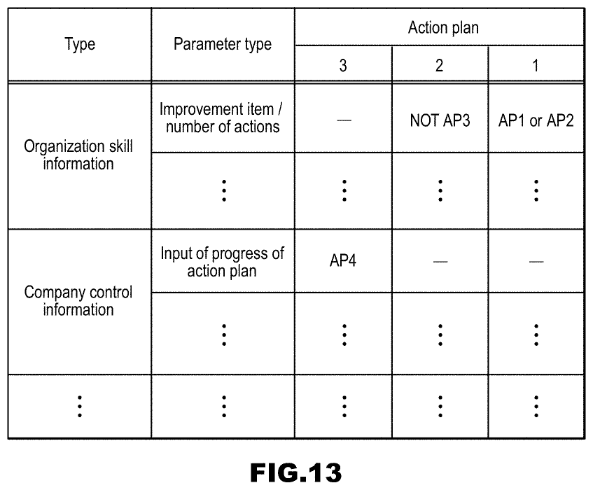

Furthermore, the action plan management table shown in FIG. 13 is stored in the action plan storage unit 117. The action plan management table manages multiple records each having “type”, “parameter type”, and “action plan”. “Type” is the type of information, and, in this example, is any one of organization skill information, business change information, company control information, and information transfer information. “Parameter type” is a parameter identifier for identifying the type of parameter (which may also be said to be “variable”). “Action plan” indicates an action plan that is to be applied, and an action plan that is not to be applied. If the parameter (value) of the parameter type “improvement item/number of actions” is “2”, “action plan” is “NOT AP3”. “NOT AP3” indicates that the action plan “AP3” is not to be applied. The parameter of the parameter type “improvement item/number of actions” being “3” indicates that the action plan “AP1” or the action plan “AP2” is to be applied.

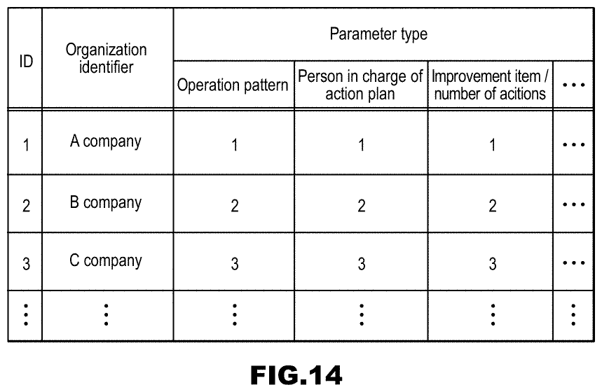

The organization parameter management table with the structure as shown in FIG. 14 is stored in the organization parameter storage unit 118. The organization parameter management table has “ID”, “organization identifier”, and “parameter type”. An attribute value of “parameter type” is a value (parameter) for each parameter type.

Hereinafter, the following three specific examples in this situation will be described. Specific Example 1 shows a case in which a parameter group of an organization is automatically set in response to a parameter setting command. Specific Example 2 shows a case in which the improvement processing unit 133 configures and transmits a questionnaire. Specific Example 3 shows a case in which the improvement processing unit 133 acquires and outputs providable information.

### SPECIFIC EXAMPLE 1

First, it is assumed that a user inputs a parameter setting command to the terminal apparatus 2. Then, the terminal accepting unit 22 of the terminal apparatus 2 accepts the parameter setting command. Next, the terminal processing unit 23 configures a parameter setting command that is to be transmitted, based on the command accepted by the terminal accepting unit 22. Next, the terminal transmitting unit 24 transmits the parameter setting command configured by the terminal processing unit 23, to the information processing apparatus 1.

Next, the command accepting unit 121 of the information processing apparatus 1 receives the parameter setting command from the terminal apparatus 2. The processing unit 13 acquires four pairs of preliminary item information and a candidate value, from the preliminary item information management table in FIG. 11. Next, the processing unit 13 configures information of the preliminary questionnaire screen, using the four acquired pairs of preliminary item information and a candidate value. The information of the questionnaire screen is described by, for example, HTML, XML, or the like, but there is no limitation on the description method. Next, the output unit 14 transmits the configured information of the preliminary questionnaire screen, to the terminal apparatus 2 from which the parameter setting command was transmitted.

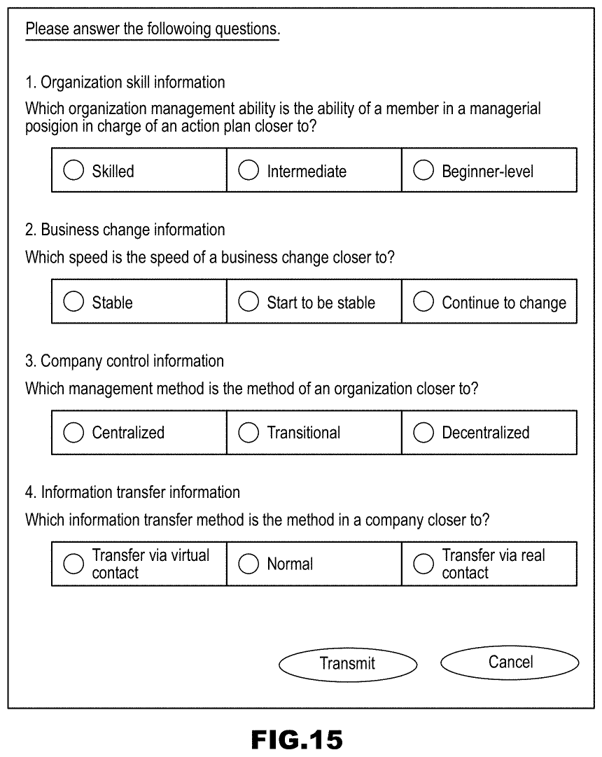

Next, the terminal receiving unit 25 of the terminal apparatus 2 receives the information of the preliminary questionnaire screen from the information processing apparatus 1, in response to the transmission of the parameter setting command. The terminal processing unit 23 configures a preliminary questionnaire screen, based on the information received by the terminal receiving unit 25. Next, the terminal output unit 26 outputs the questionnaire screen configured by the terminal processing unit 23. FIG. 15 shows an example of the preliminary questionnaire screen.

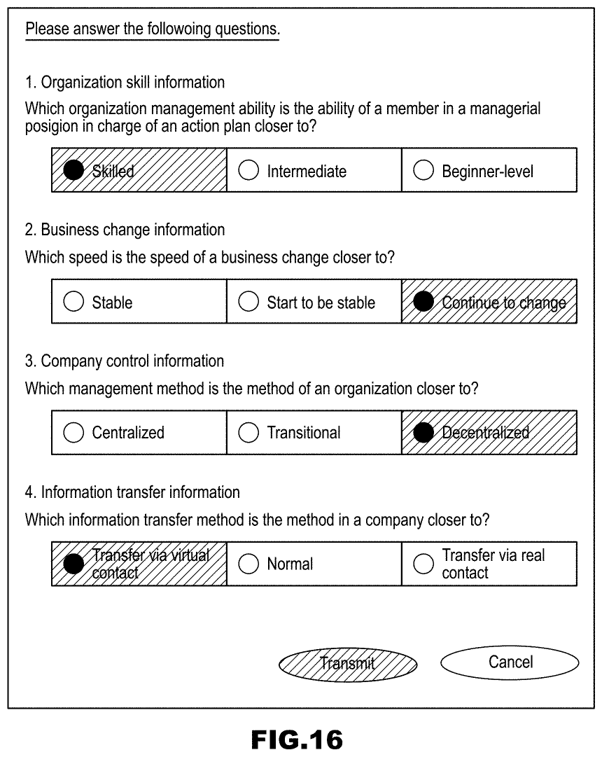

It is assumed that the user has input responses to the questions of the questionnaire screen in FIG. 15 and pressed the “transmission” button (see FIG. 16). An item that has been selected by the user out of the three items that can be selected for each question is indicated by a black circle and shading.

Then, the terminal accepting unit 22 of the terminal apparatus 2 accepts values corresponding to the items selected by the user, that is, organization skill information “3”, business change information “1”, company control information “1”, and information transfer information “3”.

Next, the terminal processing unit 23 configures information that is to be transmitted, using the information accepted by the terminal accepting unit 22. The information that is to be transmitted is “organization identifier: A company, organization skill information: 3, business change information: 1, company control information: 1, information transfer information: 3”. That is to say the terminal processing unit 23 reads the organization identifier “A company” of the terminal storage unit 21, and configures information that is to be transmitted, based on the organization identifier “A company”, the accepted organization skill information, and the like. Next, the terminal transmitting unit 24 transmits the information configured by the terminal processing unit 23 to the information processing apparatus 1.

Next, the information accepting unit 122 of the information processing apparatus 1 receives “organization identifier: A company organization skill information: 3, business change information: 1, company control information: 1, information transfer information: 3”.

Next, the parameter accumulating unit 131 acquires the received organization identifier “A company”.

Next, the parameter accumulating unit 131 acquires parameters “operation pattern: 3 (meaning: SeePlanDo/Check&Action)”, “person in charge of action plan: 3 (meaning: low employment position)” . . . corresponding to the organization skill information “3”, parameters “frequency for conducting engagement survey: 1”, “time to conduct engagement survey: 1” . . . corresponding to the business change information “1”, parameters “target sector: 1” . . . corresponding to the company control information “1”, and parameters “survey conducting method: 3” . . . corresponding to the information transfer information “3”, from the reference parameter management table in FIG. 12.

Next, the parameter accumulating unit 131 accumulates the one or more parameters in the organization parameter management table with the structure shown in FIG. 14, in association with the acquired organization identifier “A company”. Through this processing, the parameters of A company are automatically set.

It is also possible that the parameter accumulating unit 131 accumulates “organization skill information: 3, business change information: 1, company control information: 1, information transfer information: 3” received by the information accepting unit 122, in association with the organization identifier “A company”. In this case, the attribute values (parameters) in the reference parameter management table shown in FIG. 12 are such that a value (parameter) for each parameter type is acquired as necessary from the reference parameter management table, using “organization skill information: 3, business change information: company control information: 1, information transfer information: 3”.

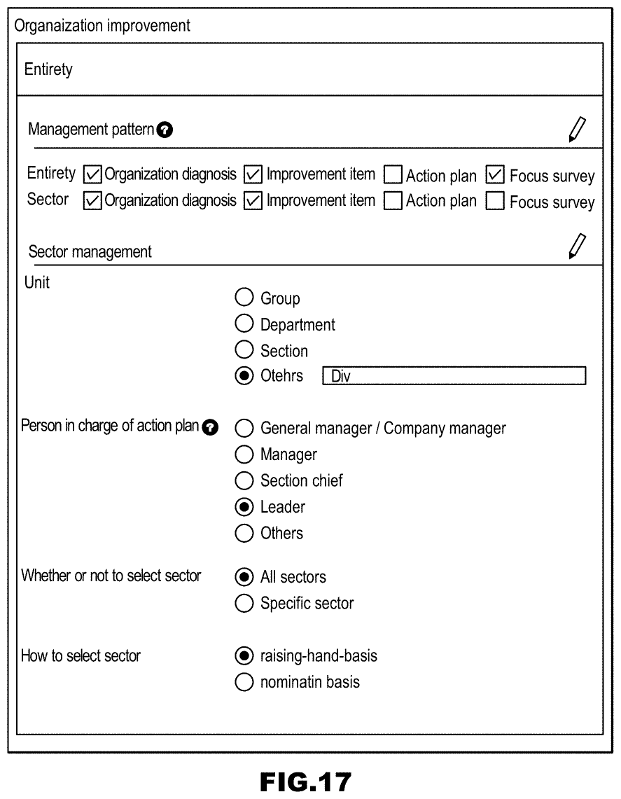

FIG. 17 shows a screen example in the case in which the thus set parameter group of A company is displayed on the terminal apparatus 2.

### SPECIFIC EXAMPLE 2

It is assumed that a user inputs a questionnaire conducting command to the terminal apparatus 2. Then, the terminal accepting unit 22 of the terminal apparatus 2 accepts the questionnaire conducting command. Next, the terminal processing unit 23 configures a questionnaire conducting command that is to be transmitted, based on the command accepted by the terminal accepting unit 22. Next, the terminal transmitting unit 24 transmits the questionnaire conducting command configured by the terminal processing unit 23, to the information processing apparatus 1. The questionnaire conducting command that is to be transmitted has an organization identifier (e.g., “A company”).

Next, the command accepting unit 121 of the information processing apparatus 1 receives the questionnaire conducting command from the terminal apparatus 2.

Next, the improvement processing unit 133 acquires an organization identifier “A company” corresponding to the received questionnaire conducting command.

Next, the improvement processing unit 133 acquires one or more parameters paired with the acquired organization identifier “A company” and corresponding to the questionnaire conducting command, from the organization parameter management (FIG. 14).

The parameter acquired in this case is, for example, “intervals between focus survey's conducted: every week˜every other week”. It is assumed that, for example, “organization diagnosis”, “improvement item”, and “action plan” are OFF, and only “focus survey” is “ON”, out of the acquired parameters “organization diagnosis”, “improvement item”, “action plan”, and “focus survey”. Only “focus survey” being “ON” indicates that a questionnaire is configured using only item information corresponding to “focus survey”.

Next, the improvement processing unit 133 acquires the conduction time “2018/8/11” of the previous questionnaire “focus survey”, which is information paired with the organization identifier “A company”. Next, the improvement processing unit 133 acquires the today's date “2018/8/18” from an unshown clock. Next, the improvement processing unit 133 acquires a difference “7 days (1 week)” between the previous conduction time “2018/8/11” and the today's date “2018/8/18”, and judges that the difference satisfies “intervals between focus surveys conducted: every week˜every other week”. That is to say, the improvement processing unit 133 judges to conduct a focus survey.

Next, the improvement processing unit 133 acquires item information corresponding to the “focus survey” being “ON”, from the item information management table in FIG. 7. That is to say, the improvement processing unit 133 acquires records with the question Nos. “1” to “4” from the table in FIG. 7. The improvement processing unit 133 configures screen information for the focus survey, using the “item” and “question: satisfaction level” with the question Nos. “1” to “4”.

Next, the improvement processing unit 133 transmits the configured questionnaire (the screen information for the focus survey) to the terminal apparatus 2 from which the command was transmitted.

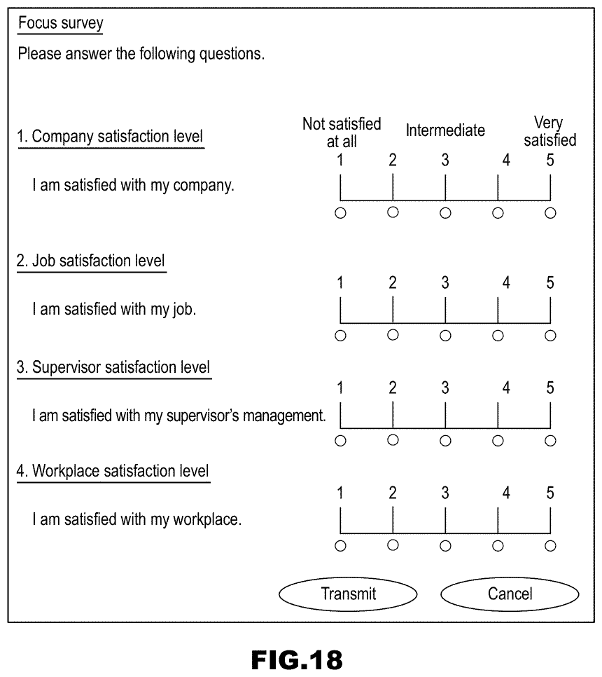

Next, the terminal receiving unit 25 of the terminal apparatus 2 receives the screen information for the focus survey from the information processing apparatus 1. Next, the terminal processing unit 23 configures a screen for the focus survey based on the screen information for the focus survey. Next, the terminal output unit 26 outputs the screen for the focus survey. FIG. 18 shows a screen example of the focus survey.

When the user inputs responses to the screen for the focus survey and presses the “transmission” button, a questionnaire is conducted. It is assumed that the responses of the questionnaire is transmitted to the information processing apparatus 1 and accumulated therein.

### SPECIFIC EXAMPLE 3

First, it is assumed that a user inputs an information providing command to the terminal apparatus 2. Then, the terminal accepting unit 22 of the terminal apparatus 2 accepts the information providing command. Next, the terminal processing unit 23 configure an information providing command that is to be transmitted, based on the command accepted by the terminal accepting unit 22. Next, the terminal transmitting unit 24 transmits the information providing command configured by the terminal processing unit 23, to the information processing apparatus 1. The information providing command that is to be transmitted has an organization identifier (e.g., “A company”).

Next, the command accepting unit 121 of the information processing apparatus 1 receives the information providing command from the terminal apparatus 2.

Next, the improvement processing unit 133 acquires an organization identifier “A company” corresponding to the received information providing command.

Next, the improvement processing unit 133 acquires one or more parameters paired with the acquired organization identifier “A company” and corresponding to the information providing command, from the organization parameter management table (FIG. 14).

Next, the improvement processing unit 133 acquires one or more pieces of providable information corresponding to the one or more parameters, from the reference parameter management table (FIG. 12).

The improvement processing unit 133 transmits the acquired one or more pieces of providable information, to the terminal apparatus 2 from which the command was transmitted.

Next, the terminal receiving unit 25 of the terminal apparatus 2 receives one or more pieces of providable information, from the information processing apparatus 1. Next, the terminal processing unit 23 configures one or more pieces of providable information that are to be output. Next, the terminal output unit 26 outputs the configured one or more pieces of providable information.

As described above, according to this embodiment, it is easy to suitably realize the function of the information processing apparatus for improving an organization.

More specifically, according to this embodiment, it is possible to set various parameters for use in the information processing apparatus, based on input from a user, without using special know-how of a consultant. Accordingly it is possible to operate the information processing apparatus, without depending on the ability of a consultant.

Furthermore, according to this embodiment, it is easy to suitably conduct a questionnaire in order to improve an organization.

Furthermore, according to this embodiment, it is easy to propose a proper action plan in order to improve an organization.

Furthermore, according to this embodiment, it is easy to conduct a questionnaire at a suitable point in time in order to improve an organization.

Furthermore, according to this embodiment, it is easy to conduct a questionnaire using a suitable method in order to improve an organization.

Furthermore, according to this embodiment, it is easy to provide information in order to improve an organization.

Moreover, according to this embodiment, it is possible to properly set a parameter before conducting a questionnaire for improving an organization.

The processing in this embodiment may be realized by software. The software may be distributed by software downloads or the like. Furthermore, the software may be distributed in a form where the software is stored in a storage medium such as a CD-ROM. Note that the same is applied to other embodiments described in this specification. The software that realizes the information processing apparatus in this embodiment is the following sort of program. Specifically, this program is, a program for causing a computer capable of accessing: a reference parameter storage unit in which one or more parameters that are used by an information processing apparatus are stored for each of one or more types of information out of organization skill information regarding an ability to implement a plan for an organization, business change information regarding a change in an environment of business that is done by an organization, company control information regarding control in an organization, and information transfer information regarding how information is transferred in an organization, and for each piece of information that each type of information can have; and an organization parameter storage unit in which one or more parameters are stored in association with an organization identifier for identifying an organization, to function as: an information accepting unit that accepts one or more types of information out of organization skill information, business change information, company control information, and information transfer information, in association with an organization identifier for identifying an organization; a parameter accumulating unit that acquires one or more parameters respectively corresponding to the one or more types of information accepted by the accepting unit, from the reference parameter storage unit, and accumulates the one or more parameters in association with an organization identifier associated with the one or more types of information accepted by the accepting unit, in the organization parameter storage unit; a command accepting unit that accepts a command associated with an organization identifier; a parameter acquiring unit that acquires one or more parameters paired with an organization identifier contained in the command accepted by the command accepting unit, from the organization parameter storage unit; and an improvement processing unit that performs processing for improving an organization, using the one or more parameters acquired by the parameter acquiring unit.

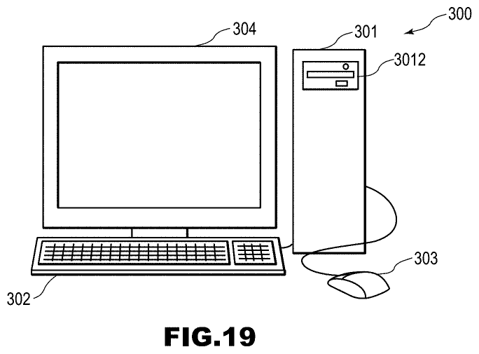

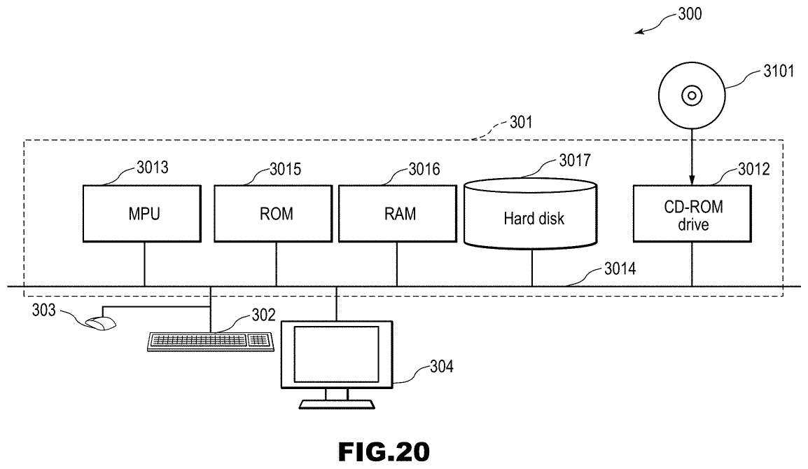

FIG. 19 shows the external appearance of a computer that executes the program described in this specification to realize the information processing apparatus 1 and the like in the foregoing various embodiments. The foregoing embodiments may be realized using computer hardware and a computer program executed thereon. FIG. 19 is a schematic view of a computer system 300. FIG. 20 is a block diagram of the system 300. FIGS. 19 and 20 show the external appearance and the like of a computer that realizes the engagement system.

In FIG. 19, the computer system 300 includes a computer 301 including a CD-ROM drive 3012, a keyboard 302, a mouse 303, and a monitor 304.

In FIG. 20, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which an application program, a system program, and data are stored. Although not shown, the computer 301 may further include a network card that provides connection to a LAN.

The program for causing the computer system 300 to execute the functions of the information processing apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or directly from a network.

The program does not necessarily have to include, for example, an operating system (OS) or a third party program to cause the computer 301 to execute the functions of the information processing apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed by hardware, for example, processing performed by a modem or an interface card in the transmitting step (processing that can be performed only by hardware) is not included.

Furthermore, the computer that executes the program may be a single computer, or may be multiple computers. That is to say centralized processing may be performed, or distributed processing may be performed.

Furthermore, in the foregoing embodiments, it will be appreciated that at least two communication parts in one apparatus may be physically realized by one medium.

In the foregoing embodiments, each process may be realized as centralized processing using a single apparatus, or may be realized as distributed processing using multiple apparatuses. That is to say, the information processing apparatus 1 may be a stand-alone apparatus. If the information processing apparatus 1 is a stand-alone apparatus, the accepting unit 12 accepts instructions, information, or the like from users or the like. The output unit 14 outputs information and the like through displaying, sound output, or transmission to a display apparatus.

The present invention is not limited to the embodiment set forth herein. Various modifications are possible within the scope of the present invention.

### INDUSTRIAL APPLICABILITY

As described above, the information processing apparatus according to the present invention has the effect of making it possible to suitably realize the function of the information processing apparatus for improving an organization, and thus this apparatus is useful as a server apparatus and the like.

1. An information processing apparatus for improving an organization, comprising:
a reference parameter storage unit in which one or at least two parameters that are used by the information processing apparatus are stored for each of one or more types of information out of organization skill information regarding an ability to implement a plan for an organization, business change information regarding a change in an environment of business that is done by an organization, company control information regarding control in an organization, and information transfer information regarding how information is transferred in an organization, and for each piece of information that each type of information can have;
an organization parameter storage unit in which one or at least two parameters are stored in association with an organization identifier for identifying an organization;
an information accepting unit that accepts one or at least two types of information out of organization skill information, business change information, company control information, and information transfer information, in association with an organization identifier for identifying an organization;
a parameter accumulating unit that acquires one or more parameters respectively corresponding to the one or more types of information accepted by the information accepting unit, from the reference parameter storage unit, and accumulates the one or more parameters in association with an organization identifier associated with the one or more types of information accepted by the information accepting unit, in the organization parameter storage unit;
a command accepting unit that accepts a command associated with an organization identifier;
a parameter acquiring unit that acquires one or more parameters paired with an organization identifier contained in the command accepted by the command accepting unit, from the organization parameter storage unit; and
an improvement processing unit that performs processing for improving an organization, using the one or more parameters acquired by the parameter acquiring unit.

2. The information processing apparatus according to claim 1, further comprising:
an item information storage unit in which one or more pieces of item information are stored in association with each of at least two parameters,
wherein one or more parameters that are used to conduct a questionnaire for an organization improvement are stored in association with an organization identifier in the organization parameter storage unit, and
the improvement processing unit that acquires one or more pieces of item information corresponding to the one or more parameters acquired by the parameter acquiring unit, from the item information storage unit, and configures and outputs a questionnaire.

3. The information processing apparatus according to claim 1, further comprising:
an action plan storage unit in which one or more action plans for an organization improvement are stored in association with each of at least two parameters,
wherein one or more parameters that are used to propose an action plan for an organization improvement are stored in association with an organization identifier in the organization parameter storage unit, and
the improvement processing unit acquires one or more action plans for an organization improvement from the action plan storage unit, using the one or more parameters acquired by the parameter acquiring unit, and outputs the action plans.

4. The information processing apparatus according to claim 1,
wherein a parameter regarding a frequency for conducting a questionnaire for an organization improvement is stored in association with an organization identifier in the organization parameter storage unit, and
the improvement processing unit outputs prompting information for prompting conduction of a questionnaire such that the frequency matches the parameter regarding the conduction frequency.

5. The information processing apparatus according to claim 1,
wherein a parameter regarding a method for conducting a questionnaire for an organization improvement is stored in association with an organization identifier in the organization parameter storage unit, and
the improvement processing unit accepts a response of a questionnaire through a different route according to the parameter regarding the conducting method, and accumulates the response.

6. The information processing apparatus according to claim 1,
wherein providable information that is provided to an organization is stored in association with a parameter in the reference parameter storage unit, and
the improvement processing unit acquires and outputs providable information paired with each of the one or more parameters acquired by the parameter acquiring unit.

7. The information processing apparatus according to claim 1, further comprising:
a preliminary item information storage unit in which one or more pieces of preliminary item information are stored, the preliminary item information being item information for deciding on one or more types of information out of organization skill information, business change information, company control information, and information transfer information; and
a preliminary item information output unit that outputs the one or more pieces of preliminary item information,
wherein the improvement processing unit accepts a response of a questionnaire, and accumulates the response,
the preliminary item information output unit outputs the one or more pieces of preliminary item information before the improvement processing unit accepts a response of a first questionnaire, and
the information accepting unit accepts one or more types of information out of organization skill information, business change information, company control information, and information transfer information, in response to outputs of the one or more pieces of preliminary item information.

8. An information processing method realized using:
a reference parameter storage unit in which one or more parameters that are used by an information processing apparatus are stored for each of one or more types of information out of organization skill information regarding an ability to implement a plan for an organization, business change information regarding a change in an environment of business that is done by an organization, company control information regarding control in an organization, and information transfer information regarding how information is transferred in an organization, and for each piece of information that each type of information can have;
an organization parameter storage unit in which one or more parameters are stored in association with an organization identifier for identifying an organization;
an information accepting unit;
a parameter accumulating unit;
a command accepting unit;
a parameter acquiring unit;
an improvement processing unit, the method comprising:
an information accepting step of the information accepting unit accepting one or more types of information out of organization skill information, business change information, company control information, and information transfer information, in association with an organization identifier for identifying an organization;
a parameter accumulating step of the parameter accumulating unit acquiring one or more parameters respectively corresponding to the one or more types of information accepted in the information accepting step, from the reference parameter storage unit, and accumulating the one or more parameters in association with an organization identifier associated with the one or more types of information accepted in the information accepting step, in the organization parameter storage unit;
a command accepting step of the command accepting unit accepting a command associated with an organization identifier;
a parameter acquiring step of the parameter acquiring unit acquiring one or more parameters paired with an organization identifier contained in the command accepted in the command accepting step, from the organization parameter storage unit; and
an improvement processing step of the improvement processing unit performing processing for improving an organization, using the one or more parameters acquired in the parameter acquiring step.

9. A storage medium on which a program is stored, the program causing a computer capable of accessing:
a reference parameter storage unit in which one or more parameters that are used by an information processing apparatus are stored for each of one or more types of information out of organization skill information regarding an ability to implement a plan for an organization, business change information regarding a change in an environment of business that is done by an organization, company control information regarding control in an organization, and information transfer information regarding how information is transferred in an organization, and for each piece of information that each type of information can have; and
an organization parameter storage unit in which one or more parameters are stored in association with an organization identifier for identifying an organization, to function as:
an information accepting unit that accepts one or more types of information out of organization skill information, business change information, company control information, and information transfer information, in association with an organization identifier for identifying an organization;
a parameter accumulating unit that acquires one or more parameters respectively corresponding to the one or more types of information accepted by the information accepting unit, from the reference parameter storage unit, and accumulates the one or more parameters in association with an organization identifier associated with the one or more types of information accepted by the information accepting unit, in the organization parameter storage unit;
a command accepting unit that accepts a command associated with an organization identifier;
a parameter acquiring unit that acquires one or more parameters paired with an organization identifier contained in the command accepted by the command accepting unit, from the organization parameter storage unit; and
an improvement processing unit that performs processing for improving an organization, using the one or more parameters acquired by the parameter acquiring unit.
